(19) United States
(12) Patent Application Publication
(10) Pub. No.: US 2022/0209297 A1
(43) Pub. Date: Jun. 30, 2022

(54) NONFLAMMABLE ELECTROLYTES

(71) Applicant: Battelle Memorial Institute, Richland, WA (US)

(72) Inventors: Jie Xiao, Richland, WA (US); Bingbin Wu, Richland, WA (US); Dianying Liu, Richland, WA (US)

(73) Assignee: Battelle Memorial Institute, Richland, WA (US)

(21) Appl. No.: 17/552,340

(22) Filed: Dec. 15, 2021

Related U.S. Application Data
(60) Provisional application No. 63/131,576, filed on Dec. 29, 2020.

(51) Int. Cl. H01M 10/0568; H01M 10/052; H01M 10/0569; H01M 4/66

(52) U.S. Cl. CPC H01M 10/0568; H01M 10/052; H01M 2300/0028; H01M 4/662; H01M 10/0569

(57) ABSTRACT

A nonflammable electrolyte comprises (a) at least four different salts; and a solvent comprising >50 vol % to 100 vol % of a flame retardant compound and optionally a cosolvent, wherein ((i) each salt comprises an anion with a different chemical composition than an anion of each of the other salts, (ii) cations of each of the salts are the same, the cations comprising lithium cations, sodium cations, or potassium cations, and (iii) a concentration of each of the salts is 5 mol % of a total molar concentration of the salts in the electrolyte; or (b) a difluoro(oxalato)borate or bis(oxalato)borate salt wherein a concentration of the salt is 40 mol % to 100 mol % of a total molar concentration of salts in the electrolyte, and a solvent comprising a flame retardant compound comprising an organic phosphate and a cosolvent comprising an organic carbonate solvent.

### CROSS-REFERENCE TO RELATED APPLICATION

This application claims the benefit of the earlier filing date of U.S. Provisional Application No. 63/131,576, filed Dec. 29, 2020, which is incorporated by reference in its entirety herein.

### ACKNOWLEDGMENT OF GOVERNMENT SUPPORT

This invention was made with Government support under Contract No. DE-AC05-76RL01830 awarded by the U.S. Department of Energy. The Government has certain rights in the invention.

### FIELD

This invention is directed to nonflammable electrolytes for use in rechargeable batteries.

### SUMMARY

This disclosure concerns nonflammable electrolytes for use in rechargeable batteries. Rechargeable batteries comprising the nonflammable electrolytes also are disclosed.

In some embodiments, a nonflammable electrolyte comprises a solution comprising at least four different salts, wherein (i) each salt comprises an anion with a different chemical composition than an anion of each of the other salts, (ii) cations of each of the salts are the same, the cations comprising lithium cations, sodium cations, or potassium cations, and (iii) a concentration of each of the salts is 5 mol % of a total molar concentration of the salts in the solution, and a solvent comprising >50 vol % to 100 vol % of a flame retardant compound and 0 vol % to 50 vol % of a cosolvent. In certain embodiments, the solution comprises 4-10 different salts. In any of the foregoing or following embodiments, each of the salts may be present in an amount of from 10 mol % to 70 mol % of the total molar concentration of the salts. In any of the foregoing or following embodiments, each salt may comprise an anion selected from bis(fluorosulfonyl)imide (FSI⁻), bis(trifluoromethanesulfonyl)imide (TFSI⁻), bis(pentafluoroethanesulfonyl)imide (BETI⁻), bis(oxalato)borate (BOB⁻), difluoro(oxalato)borate (DFOB⁻), tris(pentafluoroethyl)trifluorophosphate (FAP⁻), PO₂F₂⁻, PF₆⁻, AsF₆⁻, BF₄⁻, CF₃SO₃⁻, ClO₄⁻, I, Br⁻, Cl⁻, SCN⁻, NO₃⁻, NO₂⁻, and SO₄²⁻. In some embodiments, the nonflammable electrolyte comprises DFOB⁻ or BOB⁻ in a molar concentration that is greater than a molar concentration of any other anion in the nonflammable electrolyte and is 70 mol % of a total molar concentration of the anions of the salts in the solution. In any of the foregoing or following embodiments, the flame retardant compound may comprise an organic phosphate, an organic phosphite, an organic phosphonate, an organic phosphoramide, a phosphazene, or any combination thereof. In any of the foregoing or following embodiments, the cosolvent may comprise an organic carbonate solvent, an ether solvent, an organic sulfoxide, a sulfone, an organic nitrogen-containing solvent, or any combination thereof. In some embodiments, the flame retardant compound comprises triethyl phosphate and/or the cosolvent comprises ethylene carbonate.

In some embodiments, the nonflammable electrolyte comprises a solution comprising a difluoro(oxalato)borate (DFOB) or bis(oxalato)borate (BOB) salt comprising lithium cations, sodium cations, or potassium cations, wherein a concentration of the DFOB or BOB salt is 30 mol % to 100 mol % of a total molar concentration of salts in the solution, and a solvent comprising 60 vol % to 90 vol % of a flame retardant compound comprising an organic phosphate and 10 vol % to 40 vol % of a cosolvent comprising an organic carbonate solvent. In some embodiments, the concentration of the DFOB or BOB salt is 30 mol % to 70 mol % of the total molar concentration of the salts in the solution, and the solution further comprises a second salt, the second salt having a different anion than the DFOB or BOB salt, wherein cations of the second salt are the same as the cations of the DFOB or BOB salt and a concentration of the second salt is 30 mol % to 70 mol % of the total molar concentration of the salts in the solution. In any of the foregoing or following embodiments, the anion of the second salt may be FSI⁻, TFSI⁻, BOB⁻, DFOB⁻, PO₂F₂⁻, PF₆⁻, BF₄⁻, or ClO₄⁻. In some implementations, the concentration of the DFOB or BOB salt is 30 mol % to 70 mol % of the total molar concentration of the salts in the solution, and the solution further comprises a second salt and a third salt, each of the second and third salts having anions with a different chemical composition than the anion of the DFOB or BOB salt, and the second salt having an anion with a different chemical composition than the anion of the third salt, wherein cations of the second and third salts are the same as the cations of the DFOB or BOB salt and a combined concentration of the second and third salts is 30 mol % to 70 mol % of the total molar concentration of the salts in the solution. In certain embodiments, the flame retardant compound comprises triethyl phosphate and/or the cosolvent comprises ethylene carbonate.

Embodiments of a battery system comprise a nonflammable electrolyte as disclosed herein, a cathode, and (i) anode current collector in the absence of an anode or (ii) an anode. The anode may comprise lithium metal, sodium metal, potassium metal, an intercalation material, or a conversion compound. In some embodiments, the battery system is a pouch cell comprising the anode current collector in the absence of the anode or the anode, wherein the anode comprises lithium metal, sodium metal, or potassium metal; the cathode, the separator, the nonflammable electrolyte, and a packaging material defining a pouch enclosing the anode, the cathode, the separator, and the nonflammable electrolyte.

The foregoing and other objects, features, and advantages of the invention will become more apparent from the following detailed description, which proceeds with reference to the accompanying figures.

### BRIEF DESCRIPTION OF THE DRAWINGS

FIGS. 1A are schematic diagrams of one exemplary embodiment of a rechargeable battery comprising an anode (1A) and one exemplary embodiment of an anode-free rechargeable battery (1B).

FIG. 2 is a schematic side elevation view of a simplified pouch cell.

FIG. 3 shows the discharge capacity of coin cells comprising four nonflammable electrolytes as disclosed herein over 300 cycles.

FIG. 4 shows the cycling stability of a 350 Wh/kg Li/NMC622 pouch cell comprising a nonflammable electrolyte as disclosed herein.

FIG. 5 is a graph showing specific capacity of seven nonflammable electrolytes with single salts in triethyl phosphate (TEP) in Li/NMC622 coin cells.

FIGS. 6A and 6B are graphs showing specific capacity of 18 nonflammable electrolytes with dual salts in TEP in Li/NMC622 coin cells.

FIG. 7 is a graph showing cycling performance of eight nonflammable electrolytes comprising a single salt in TEP/ethylene carbonate (EC) (68/32 by volume) in Li/NMC622 coin cells.

FIGS. 8A-8B are graphs showing cycling performance of 21 nonflammable electrolytes comprising dual salts in TEP/EC (68/32 by volume) in Li/NMC622 coin cells.

FIGS. 9A-9B are graphs showing cycling performance of 18 nonflammable electrolytes comprising three salts in TEP/EC (68/32 by volume) in Li/NMC622 coin cells.

### DETAILED DESCRIPTION

Flammable electrolytes are a serious concern for metal batteries, such as lithium metal, sodium metal, or potassium metal batteries. Traditional “safer” electrolytes, such as carbonate electrolytes, used for metal ion batteries do not work well in metal batteries and provide a very limited life. For instance, electrolytes comprising a single salt in a carbonate solvent are flammable and provide very poor performance in lithium metal batteries. Electrolytes comprising dual salts in carbonate solvents provide improved cycling, but remain flammable. Some flame-retardant electrolytes may provide improved cycling but are limited by high viscosity and/or possess continued safety concerns. It has been a challenge to provide an electrolyte that is safe and provides a long cycle life in Li metal, Na metal, and/or K metal batteries.

This disclosure concerns nonflammable electrolytes that are safe and provide a long cycle life. In some embodiments, the nonflammable electrolyte comprises at least four different salts and a solvent comprising >50 vol % to 100 vol % of a flame retardant compound. The flame retardant compound provides safety, while the multiple salts provide a desirable cycle life. In other embodiments, the nonflammable electrolyte comprises a difluoro(oxalato)borate (DFOB) or bis(oxalato)borate (BOB) salt wherein a concentration of the DFOB or BOB salt is 40 mol % to 100 mol % of a total molar concentration of salts in the electrolyte, and a solvent comprising 60 vol % to 90 vol % of a flame retardant compound comprising an organic phosphate and 10 vol % to 40 vol % of a cosolvent comprising an organic carbonate solvent. The flame-retardant compound provides safety, while the DFOB or BOB salt and the organic carbonate solvent in combination with the organic phosphate provide a desirable cycle life.

### I. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, molarities, voltages, capacities, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry may be found in Richard J. Lewis, Sr. (ed.), Hawley's Condensed Chemical Dictionary, published by John Wiley & Sons, Inc., 2016 (ISBN 978-1-118-13515-0).

In order to facilitate review of the various embodiments of the disclosure, the following explanations of specific terms are provided:

Additive: As used herein, the term “additive” refers to a component of an electrolyte that is present in an amount of greater than zero and less than or equal to 5 wt %.

Anode: An electrode through which electric charge flows into a polarized electrical device. From an electrochemical point of view, negatively-charged anions move toward the anode and/or positively-charged cations move away from it to balance the electrons leaving via external circuitry. In a discharging battery or galvanic cell, the anode is the negative terminal where electrons flow out. If the anode is composed of a metal, electrons that it gives up to the external circuit are accompanied by metal cations moving away from the electrode and into the electrolyte. When the battery is recharged, the anode becomes the positive terminal where electrons flow in and metal cations are reduced.

Capacity: The capacity of a battery is the amount of electrical charge a battery can deliver. The capacity is typically expressed in units of mAh, or Ah, and indicates the maximum constant current a battery can produce over a period of one hour. For example, a battery with a capacity of 100 mAh can deliver a current of 100 mA for one hour or a current of 5 mA for 20 hours. Areal capacity or specific areal capacity is the capacity per unit area of the electrode (or active material) surface, and is typically expressed in united of mAh cm⁻².

Cathode: An electrode through which electric charge flows out of a polarized electrical device. From an electrochemical point of view, positively charged cations invariably move toward the cathode and/or negatively charged anions move away from it to balance the electrons arriving from external circuitry. In a discharging battery or galvanic cell, the cathode is the positive terminal, toward the direction of conventional current. This outward charge is carried internally by positive ions moving from the electrolyte to the positive cathode, where they may be reduced. When the battery is recharged, the cathode becomes the negative terminal where electrons flow out and metal atoms (or cations) are oxidized.

Cell: As used herein, a cell refers to an electrochemical device used for generating a voltage or current from a chemical reaction, or the reverse in which a chemical reaction is induced by a current. A battery includes one or more cells. The terms “cell” and “battery” are used interchangeably when referring to a battery containing only one cell.

Consists essentially of: By “consists essentially of” is meant that the electrolyte does not include other components that materially affect the properties of the electrolyte alone or in a system including the electrolyte. For example, the electrolyte does not include any electrochemically active component (i.e., a component (an element, an ion, or a salt) that is capable of forming redox pairs having different oxidation and reduction states, e.g., ionic species with differing oxidation states or a metal cation and its corresponding neutral metal atom), other than the recited salts, in an amount sufficient to affect performance of the electrolyte, additional solvents other than the flame retardant compound and any recited cosolvent, or other additives in a significant amount (e.g., >1 wt %).

Conversion compound: A compound comprising one or more cations, which are displaced by another metal when a battery is discharged. For example, when iron (II) selenide (FeSe) is used as a cathode material, Fe is replaced by Na during discharge of a Na battery:

2Na+FeSe↔Na₂Se+Fe

Coulombic efficiency (CE): The efficiency with which charges are transferred in a system facilitating an electrochemical reaction. CE may be defined as the amount of charge exiting the battery during the discharge cycle divided by the amount of charge entering the battery during the charging cycle. CE of Li∥Cu or Na∥Cu cells may be defined as the amount of charge flowing out of the battery during stripping process divided by the amount of charge entering the battery during plating process.

Depth of discharge (DOD): The term “depth of discharge” represents the percentage of the battery that has been discharged relative to the overall capacity of the battery.

EC: ethylene carbonate

EMC: ethyl methyl carbonate

End of life (EOL): The point at which a battery will hold only a set percentage of its original capacity. For example, 80% EOL means the point at which the battery still has 80% of the original capacity after being charged/discharged for a number of cycles.

Flammable: The term “flammable” refers to a material that will ignite easily and burn rapidly. As used herein, the term “nonflammable” means that an electrolyte, will not ignite or burn due to operation of an electrochemical device including the electrolyte. Flammability can be measured by determining the self-extinguishing time (SET) of the electrolyte, by determining whether the electrolyte ignites when exposed to direct contact with a flame, and/or by determining the flashpoint of the electrolyte. The SET is determined by a modified Underwriters Laboratories test standard 94 HB. An electrolyte is immobilized on an inert ball wick, such as a ball wick having a diameter of ˜0.3-0.5 cm, which is capable of absorbing 0.05-0.10 g electrolyte. The wick is then ignited, and the time for the flame to extinguish is recorded. The time is normalized against the sample weight. If the electrolyte does not catch flame, the SET is zero and the electrolyte is nonflammable. Electrolytes having SET of <6 s/g (e.g., the flame extinguishes within ˜0.5 s) are also considered nonflammable. Alternatively, an open container of the electrolyte may be contacted directly with a flame, e.g., a flame from a butane lighter. If the electrolyte does not ignite after 5 seconds of direct contact with the flame, then the electrolyte is nonflammable. An electrolyte also is considered nonflammable if it has a flashpoint >93° C. according to GHS classification criteria , e.g., as determined by ASTM D 3243, D 3278 and D 3828.

Intercalation material: A compound capable of intercalating ions reversibly without irreversible change in its microstructure. For example, a lithium ion intercalation material is capable of intercalating lithium ions. One example of a lithium ion intercalation material is graphite, which is often used in lithium-ion batteries. Lithium ions intercalate into the carbon structure to form LiC_{6.} Lithium ions can also be extracted from LiC₆ to re-form graphite without irreversible change in its microstructure.

KFSI: potassium bis(fluorosulfonyl)imide

KTFSI: potassium bis(trifluoromethanesulfonyl)imide

LiBETI: lithium bis(pentafluoroethanesulfonyl)imide

LiFSI: lithium bis(fluorosulfonyl)imide

LiTFSI: lithium bis(trifluoromethanesulfonyl)imide

LiBOB: lithium bis(oxalato)borate

LiDFOB: lithium difluoro(oxalato)borate

LSE: localized superconcentrated electrolyte

NaFSI: sodium bis(fluorosulfonyl)imide

NaTFSI: sodium bis(trifluoromethylsulfonyl)imide

NaBOB: sodium bis(oxalato)borate

Organophosphorus compound: An organic compound that contains phosphorus.

PC: propylene carbonate

Phosphate: As used herein, phosphate refers to an organophosphate having a general formula P(═O)(OR)3 where each R independently is alkyl (e.g., C₁-C₁₀ alkyl) or aryl. Each alkyl or aryl group may be substituted or unsubstituted.

Phosphazene: A compound in which a phosphorus atom is covalently linked to a nitrogen atom or nitrogen-containing group by a double bond and to three other atoms or radicals by single bonds.

Phosphite: As used herein, phosphite refers to an organophosphite having a general formula P(OR)₃ or HP(O)(OR)₂ where each R independently is alkyl (e.g., C₁-C₁₀ alkyl) or aryl. Each alkyl or aryl group may be substituted or unsubstituted.

Phosphonate: A compound having a general formula P(═O)(OR)₂(R′) wherein each R and R′ independently is alkyl (e.g., C₁-C₁₀ alkyl), or aryl. Each alkyl or aryl group may be substituted or unsubstituted.

Phosphoramide: A compound having a general formula P(═O)(NR₂)₃ wherein each R independently is hydrogen, alkyl (e.g., C₁-C₁₀ alkyl), or alkoxy (e.g., C₁-C₁₀ alkoxy). At least one R is not hydrogen. Each alkyl or aryl group may be substituted or unsubstituted. Primary salt: The term “primary salt” when used with multiple-salt electrolytes, refers to the salt present in a greater concentration than any of the other salts in the electrolyte.

Separator: A battery separator is a porous sheet or film placed between the anode and cathode. It prevents physical contact between the anode and cathode while facilitating ionic transport.

Soluble: Capable of becoming molecularly or ionically dispersed in a solvent to form a homogeneous solution. As used herein, the term “soluble” means that a salt has a solubility in a given solvent of at least 1 mol/L (M, molarity) or at least 1 mol/kg (m, molality).

Solution: A homogeneous mixture composed of two or more substances. A solute (minor component) is dissolved in a solvent (major component). A plurality of solutes and/or a plurality of solvents may be present in the solution.

### II. Nonflammable Electrolytes

In some embodiments, a nonflammable electrolyte is a solution comprising at least four different salts, a solvent comprising >50 vol % to 100 vol % of a flame retardant compound and 0 vol % to 50 vol % of a cosolvent. Each salt comprises an anion with a different chemical composition than an anion of each of the other salts. Cations of each of the salts are the same, the cations comprising lithium cations, sodium cations, or potassium cations. A concentration of each of the salts is 5 mol % of a total molar concentration of the salts in the solution.

In other embodiments, a nonflammable electrolyte is a solution comprising a difluoro(oxalato)borate (DFOB) or bis(oxalato)borate (BOB) salt comprising lithium cations, sodium cations, or potassium cations, and a solvent comprising 60 vol % to 90 vol % of a flame retardant compound comprising an organic phosphate and 10 vol % to 40 vol % of a cosolvent comprising an organic carbonate solvent. A concentration of the DFOB or BOB salt is 40 mol % to 100 mol % of a total molar concentration of salts in the solution.

In any of the foregoing or following embodiments, the nonflammable electrolyte may exhibit low volatility. In some embodiments, the electrolyte loses less than 5 wt % of an initial mass of the electrolyte upon exposure to air for 24 hours, such as less than 2 wt %, less than 1 wt %, less than 0.5 wt %, less than 0.3 wt %, or less than 0.2 wt % of the initial mass over 24 hours. In one example, a nonflammable electrolyte as disclosed herein lost only 0.165% of its mass when exposed to dry air having an airflow of 100 m/minute and a dew point of −51° C. In contrast, conventional flammable electrolytes, such as carbonate-based electrolytes, may lose at least 30 wt % of their initial mass under similar conditions.

### A. Solvents

In any of the foregoing or following embodiments, the flame retardant compound may comprise an organic phosphate, an organic phosphite, an organic phosphonate, an organic phosphoramide, a phosphazene, or any combination thereof. In some embodiments, the flame retardant compound comprises triethyl phosphate (TEP), trimethyl phosphate (TMP), tributyl phosphate, triphenyl phosphate, tris(2,2,2-trifluoroethyl) phosphate, bis(2,2,2-trifluoroethyl) methyl phosphate, triphenyl phosphite, tris(2,2,2-trifluoroethyl) phosphite; dimethyl methylphosphonate, diethyl ethylphosphonate, diethyl phenylphosphonate, bis(2,2,2-trifluoroethyl) methylphosphonate; hexamethylphosphoramide; hexamethoxyphosphazene, hexafluorophosphazene, or any combination thereof. In certain embodiments, the flame retardant compound is TEP.

The solvent comprises>50 vol % to 100 vol % of the flame retardant compound. In some embodiments, the flame retardant is 55 vol % to 100 vol % of the solvent, such as 60 vol % to 100 vol %, 60 vol % to 95 vol %, 60 vol % to 90 vol %, 60 vol % to 80 vol %, or 60 vol % to 70 vol %. The remainder of the solvent may be one or more cosolvents.

Thus, in any of the foregoing or following embodiments, the solvent may further comprise a cosolvent. In some embodiments, the cosolvent comprises an organic carbonate solvent, an ether solvent, an organic sulfoxide, a sulfone, an organic nitrogen-containing solvent, or any combination thereof. Suitable cosolvents include, but are not limited to, ethylene carbonate (EC), dimethyl carbonate (DMC), vinylene carbonate (VC), fluoroethylene carbonate (FEC), difluoroethylene carbonate (DFEC), trifluoroethylene carbonate (TFEC), vinyl ethylene carbonate (VEC), 4-methylene ethylene carbonate (MEC), propylene carbonate (PC), ethyl methyl carbonate (EMC), diethyl carbonate (DEC), methyl 2,2,2-trifluoroethyl carbonate (MFEC), dimethoxyethane (DME), 1,3-dioxolane (DOL), tetrahydrofuran (THF), allyl ether, dimethyl sulfoxide (DMSO), dimethyl sulfone (DMS), ethyl methyl sulfone (EMS), ethyl vinyl sulfone (EVS), tetramethylene sulfone (TMS), trifluoromethyl ethyl sulfone (FMES), trifluoromethyl isopropyl sulfone (FMIS), trifluoropropyl methyl sulfone (FPMS), diethylene glycol dimethyl ether (diglyme), triethylene glycol dimethyl ether (triglyme), tetraethylene glycol dimethyl ether (tetraglyme), methyl butyrate, ethyl propionate, gamma-butyrolactone, acetonitrile (AN), succinonitrile (SN), adiponitrile, triallyl amine, triallyl cyanurate, triallyl isocyanurate, or any combination thereof. In some embodiments, the cosolvent is an organic carbonate solvent. In certain embodiments, the cosolvent comprises EC.

In any of the foregoing or following embodiments, the solvent may comprise from 0 vol % to 50 vol % cosolvent. In some embodiments, the solvent comprises 0 vol % to 45 vol %, 0 vol % to 40 vol %, 5 vol % to 40 vol %, 10 vol % to 40 vol %, 20 vol % to 40 vol %, 25 vol % to 40 vol %, 30 vol % to 40 vol %, or 30 vol % to 35 vol % cosolvent.

In any of the foregoing or following embodiments, the solvent may comprise TEP and EC. In some embodiments, the solvent comprises 60 vol % to 80 vol % TEP and 20 vol % to 40 vol % EC. In certain examples, the solvent comprises 65 vol % to 70 vol % TEP and 30 vol % to 35 vol % EC.

### B. Salts

### 1. Four or More Salts

In some embodiments, the nonflammable electrolyte is a solution comprising at least four different salts. Each salt comprises an anion with a different chemical composition than an anion of each of the other salts. Cations of each of the salts are the same, the cations comprising lithium cations, sodium cations, or potassium cations. A concentration of each of the salts is 5 mol % of a total molar concentration of the salts in the solution. In some implementations, the nonflammable electrolyte comprises 4-10 different salts, such as 4-9, 4-8, 4-7, 4-6, or 4-5 different salts. In certain embodiments, the nonflammable electrolyte comprises 4 or 5 different salts. In any of the foregoing or following embodiments, each of the salts may be present in an amount of at least 10 mol % of the total molar concentration of the salts. In some embodiments, each of the salts is present in an amount of from 10 mol % to 70 mol % of the total molar concentration of the salts. In any of the foregoing or following embodiments, the total molar concentration of the salts in the solution may be 0.5 M to 5 M. In some embodiments, the total molar concentration of the salts in the solution is 0.5 M to 4 M, 0.5 M to 3 M, 0.5 M to 2 M, 0.7 M to 1.5 M, or 0.8 M to 1.2 M. In certain examples, the total molar concentration is 1 M.

In any of the foregoing or following embodiments, one of the salts may be present in a greater molar concentration than any other individual salt. The salt present in the greater concentration may be referred to as the primary salt. In some embodiments, the primary salt is present in an amount of from 30 mol % to 70 mol % of the total molar concentration of the at least four salts, such as an amount of from 30 mol % to 60 mol % or 30 mol % to 50 mol % of the total molar concentration of the salts. In certain embodiments, the primary salt is present in an amount that is 1.5× to 5× greater than an amount of any other individual salt, such as an amount that is 2× to 4× greater than the amount of any other individual salt. In certain implementations, there may be two salts that are each present in equal molar concentrations that greater than the molar concentration of any other individual salt. In such implementations, the two salts may be referred to a co-primary salts. Each of the co-primary salts may be present in an amount that is 1.5× to 5× greater than an amount of any other individual salt, such as an amount that is 2× to 4× greater than the amount of any other individual salt.

In any of the foregoing or following embodiments, each of the remaining salts may be present in equal concentrations or in different concentrations. In some embodiments, each of the remaining salts is present in equal concentrations. In one nonlimiting example, if the nonflammable electrolyte comprises four different salts and the primary salt comprises 33 mol % of a total molar concentration of the salts, then each of the remaining three salts may be present in an amount of 22.3 mol %. In another nonlimiting example, if the nonflammable electrolyte comprises five different salts and the primary salt comprises 50 mol % of a total molar concentration of the salts, then each of the remaining four salts may be present in an amount of 12.5 mol %. In still another nonlimiting example, the nonflammable electrolyte comprises five different salts in a molar ratio of 1/1/2/1/1. In yet another nonlimiting example, the nonflammable electrolyte comprises five different salts in a molar ratio of 1/1/4/1/1. In an independent embodiment, two or more of the remaining salts are present in different concentrations, with each molar concentration being less than a molar concentration of the primary salt.

In any of the foregoing or following embodiments, each of the salts may comprise an anion selected from bis(fluorosulfonyl)imide (FSI⁻), bis(trifluoromethanesulfonyl)imide (TFSI⁻), bis(pentafluoroethanesulfonyl)imide (BETI⁻), bis(oxalato)borate (BOB⁻), difluoro(oxalato)borate (DFOB⁻), tris(pentafluoroethyl)trifluorophosphate (FAP⁻), PO₂F₂⁻, AsF₆⁻, BF₄⁻, CF₃SO₃⁻, ClO₄⁻, I, Br⁻, SCN⁻, NO₃⁻, NO₂⁻, and SO₄²⁻. In some embodiments, the nonflammable electrolyte includes 4-6 different salts comprising anions selected from FSI⁻, TFSI⁻, DFOB⁻, BOB⁻, FB₄⁻, PF₆⁻, and PO₂F₂⁻. Exemplary salts include, but are not limited to, lithium bis(fluorosulfonyl)imide (LiN(SO₂F)_{2,} LiFSI), lithium bis(trifluoromethanesulfonyl)imide (LiN(SO₂CF₃)_{2,} LiTFSI), lithium bis(pentafluoroethanesulfonyl)imide (LiN(SO₂C₂F₅)_{2,} LiBETI), lithium bis(oxalato)borate (LiBOB), LiPO₂F_{2,} LiPF_{6,} LiAsF_{6,} LiBF_{4,} CF₃SO₃Li, LiClO_{4,} lithium difluoro(oxalato)borate (LiDFOB), Lil, LiBr, LiCl, LiSCN, LiNO_{3,} LiNO_{2,} Li₂SO_{4,} sodium bis(fluorosulfonyl)imide (NaN(SO₂F)_{2,} NaFSI), sodium bis(trifluoromethylsulfonyl)imide (NaN(SO₂CF₃)_{2,} NaTFSI), sodium bis(oxalato)borate (NaBOB), sodium difluoro(oxalato)borate (NaDFOB), sodium bis(perfluoroethanesulfonyl)imide (NaN(SO₂C₂F₅)_{2,} NaBETI), sodium tris(pentafluoroethyl)trifluorophosphate (Na[(C₂F₅)₃PF₃], NaFAP), NaPF_{6,} NaAsF_{6,} CF₃SO₃Na, NaClO₄, NaBF_{4,} NaI, NaBr, NaCl, NaSCN, NaNO_{3,} NaNO_{2,} Na₂SO_{4,} potassium bis(fluorosulfonyl)imide (KN(SO₂F)_{2,} KFSI), potassium bis(trifluoromethanesulfonyl)imide (KN(SO₂CF₃)_{2,} KTFSI), potassium bis(oxalato)borate (KBOB), potassium difluoro(oxalato)borate (KDFOB), potassium bis(perfluoroethanesulfonyl)imide (KN(SO₂C₂F₅)_{2,} KBETI), potassium tris(pentafluoroethyl)trifluorophosphate (K[(C₂F₅)₃PF₃], KFAP), KPF_{6,} KAsF_{6,} CF₃SO₃K, KClO₄, KBF_{4,} KI, KBr, KCl, KSCN, KNO_{3,} KNO_{2,} K₂SO_{4,} and combinations thereof.

In any of the foregoing or following embodiments, the nonflammable electrolyte may comprise DFOB⁻ or BOB⁻ in a molar concentration that is greater than a molar concentration of any other anion in the nonflammable electrolyte and is 70 mol % of a total molar concentration of the anions of the at least four salts. In certain embodiments, the nonflammable electrolyte may comprise both DFOB⁻ and BOB⁻ as co-primary salts, wherein the molar concentration of each of the DFOB⁻ and BOB⁻ is greater than a molar concentration of any other anion in the nonflammable electrolyte and a combined molar concentration of DFOB⁻ and BOB⁻ is 70 mol % of a total molar concentration of the anions of the at least four salts. In any of the foregoing or following embodiments, the nonflammable electrolyte may comprise 4-6 different salts with anions selected from FSI⁻, DFOB⁻, BOB⁻, BF₄⁻, PF₆⁻, and PO₂F₂⁻.

In some embodiments, the nonflammable electrolyte is intended for use in a lithium metal battery, and each of the salts comprises lithium cations. In some embodiments, the nonflammable electrolyte is intended for use in a sodium metal battery, and each of the salts comprises sodium cations. In some embodiments, the nonflammable electrolyte is intended for use in a potassium metal battery, and each of the salts comprises potassium cations.

In any of the foregoing or following embodiments, the nonflammable electrolyte may comprise at least four different salts selected from LiFSI, LiBETI, LiBOB, LiDFOB, LiPF₆, LiPO₂F_{2,} LiAsF_{6,} LiBF_{4,} CF₃SO₃Li, LiClO_{4,} LiI, LiBr, LiCl, LiSCN, LiNO_{3,} LiNO_{2,} Li₂SO_{4,} or any combination thereof. In some embodiments, the electrolyte comprises four or five different lithium salts selected from LiFSI, LiTFSI, LiDFOB, LiBOB, LiPF_{6,} and LiPO₂F_{2.} In certain embodiments, LiDFOB or LiBOB is the primary salt, and is present in a greater molar concentration than any other salt in the nonflammable electrolyte. The LiDFOB or LiBOB may be present in a molar concentration ranging from greater than a molar concentration of any other salt and ≤70 mol % of a total molar concentration of the at least four salts. In some embodiments, LiDFOB or LiBOB is present in an amount of 30 mol % to 70 mol % of the total molar concentration of the at least four salts, such as an amount of from 30 mol % to 60 mol % or 30 mol % to 50 mol % of the total molar concentration of the at least four salts.

In any of the foregoing or following embodiments, the nonflammable electrolyte may comprise at least four different salts selected from NaFSI, NaBETI, NaBOB, NaDFOB, NaPF₆, NaPO₂F_{2,} NaAsF_{6,} NaBF_{4,} CF₃SO₃Na, NaClO_{4,} NaI, NaBr, NaCl, NaSCN, NaNO_{3,} NaNO₂, Na₂SO_{4,} or any combination thereof. In some embodiments, the electrolyte comprises four or five different sodium salts selected from NaFSI, NaTFSI, NaDFOB, NaBOB, NaPF_{6,} and NaPO₂F_{2.} In certain embodiments, NaDFOB or NaBOB is the primary salt, and is present in a greater molar concentration than any other salt in the nonflammable electrolyte. The NaDFOB or NaBOB may be present in a molar concentration ranging from greater than a molar concentration of any other salt and 70 mol % of a total molar concentration of the at least four salts. In some embodiments, NaDFOB or NaBOB is present in an amount of 30 mol % to 70 mol % of the total molar concentration of the at least four salts, such as an amount of from 30 mol % to 60 mol % or 30 mol % to 50 mol % of the total molar concentration of the at least four salts.

In any of the foregoing or following embodiments, the nonflammable electrolyte may comprise at least four different salts selected from KFSI, KBETI, KBOB, KDFOB, KPO₂F_{2,} KPF_{6,} KAsF_{6,} KBF_{4,} CF₃SO₃K, KClO_{4,} KI, KBr, KCl, KSCN, KNO_{3,} KNO_{2,} K₂SO_{4,} or any combination thereof. In some embodiments, the electrolyte comprises four or five different potassium salts selected from KFSI, KTFSI, KDFOB, KBOB, KPF_{6,} and KPO₂F_{2.} In certain embodiments, KDFOB or KBOB is the primary salt, and is present in a greater molar concentration than any other salt in the nonflammable electrolyte. The KDFOB or KBOB may be present in a molar concentration ranging from greater than a molar concentration of any other salt and 70 mol % of a total molar concentration of the at least four salts. In some embodiments, KDFOB or KBOB is present in an amount of 30 mol % to 70 mol % of the total molar concentration of the at least four salts, such as an amount of from 30 mol % to 60 mol % or 30 mol % to 50 mol % of the total molar concentration of the at least four salts.

In any of the foregoing or following embodiments, the flame retardant compound may comprise TEP. In some embodiments, the nonflammable electrolyte further includes a cosolvent comprising EC. In certain embodiments, the nonflammable electrolytes comprises a combination of FSI⁻, TFSI⁻, DFOB⁻, PF₆⁻, and PO₂F₂⁻ anions, or a combination of FSI⁻, TFSI⁻, BOB⁻, PF₆⁻, and PO₂F₂⁻ anions. In one embodiment, the nonflammable electrolyte comprises LiFSI, LiTFSI, LiDFOB, LiPF_{6,} LiPO₂F_{2,} TEP, and EC. In some examples, LiDFOB is the primary salt. The LiDFOB may be present in a molar concentration that is 1.5× to 5× higher than the molar concentration of any of the other salts in the nonflammable electrolyte.

In any of the foregoing or following embodiments, the nonflammable electrolyte may consist essentially of or consist of at least four different salts as previously described and the solvent. In some embodiments, the solvent consists essentially of or consists of the flame retardant compound and the cosolvent(s). In an independent embodiment, the solvent consists essentially of or consists of the flame retardant compound.

In some embodiments, the nonflammable electrolyte comprises, consists essentially of, or consists of, LiFSI, LiTFSI, LiDFOB, LiPF_{6,} LiPO₂F_{2,} TEP, and EC. In certain embodiments, the TEP is present in an amount of 55-80 vol % or 60-70 vol % of the solvent, and the EC is present in an amount of 20-45 vol % or 30-40 vol % of the solvent. In one embodiment, the solvent comprises 55-80 vol % TEP and 20-45 vol % of a mixture of EC and DEC. In one example, the solvent comprised 60 vol % TEP, 25 mol % EC, and 15 mol % DEC. In one embodiment, the LiFSI, LiTFSI, LiDFOB, LiPF_{6,} and LiPO₂F₂ are present in a molar ratio of 1:1:2:1:1. In an independent embodiment, the LiFSI, LiTFSI, LiDFOB, LiPF_{6,} and LiPO₂F₂ are present in a molar ratio of 1:1:4:1:1. In another an independent embodiment, the LiFSI, LiTFSI, LiDFOB, LiPF_{6,} and LiPO₂F₂ are present in a molar ratio of 1:1:3:1:1. In still another independent embodiment, the nonflammable electrolyte further includes greater than 0 wt % to 5 wt % of an additive. In one example, the additive was 1 wt % LiNO_{3.} Exemplary nonflammable electrolytes include, but are not limited to, 1 M LiTFSI/LiFSI/LiDFOB/LiPF₆/LiPO₂F₂ (1/1/2/1/1 molar ratio) in TEP/EC (68/32 by volume), 1 M LiTFSI/LiFSI/LiDFOB/LiPF₆/LiPO₂F₂ (1/1/2/1/1 molar ratio) in TEP/EC (68/32 by volume)+1 wt % LiNO₃, 1 M LiTFSI/LiFSI/LiDFOB/LiPF₆/LiPO₂F₂ (1/1/4/1/1 molar ratio) in TEP/EC (68/32 by volume), and 1 M LiTFSI/LiFSI/LiDFOB/LiPF_{6/}LiPO₂F₂ (1/1/2/1/1 molar ratio) in TEP/EC/DEC (60/25/15 by volume).

In some of the foregoing embodiments, the combination of different salts provides a synergistic effect whereby the nonflammable electrolyte has an increased cycle life and/or increased stability (e.g., as evidenced by capacity retention and/or reduced gas byproduct generation) during use compared to a similar nonflammable electrolyte with the same solvent but fewer than four different salts. The cycle life and/or stability may be further enhanced when the solvent comprises a flame retardant compound and a cosolvent, particular a cosolvent comprising an organic carbonate solvent. Some nonflammable electrolytes comprising at least four different salts as disclosed herein, had a capacity retention of at least 80% over at least 200 cycles, at least 220 cycles, or at least 230 cycles and/or a capacity retention of at least 75% over at least 225 cycles, at least 250 cycles, or even at least 300 cycles.

### 2. One, Two, or Three Salts

In some embodiments, the nonflammable electrolyte is a solution comprising a difluoro(oxalato)borate (DFOB) or bis(oxalato)borate (BOB) salt comprising lithium cations, sodium cations, or potassium cations, and a solvent comprising 60 vol % to 90 vol % of a flame retardant compound comprising an organic phosphate and 10 vol % to 40 vol % of a cosolvent comprising an organic carbonate solvent. A concentration of the DFOB or BOB salt is 30 mol % to 100 mol % of a total molar concentration of salts in the solution. In certain embodiments, the DFOB or BOB salt is the only salt in the nonflammable electrolyte, other than additives which may be present in an amount of greater than zero and less than or equal to 5 wt %.

In some implementations, the concentration of the DFOB or BOB salt is 30 mol % to 70 mol % of the total molar concentration of the salts in the solution, and the solution further comprises a second salt, or a second salt and a third salt. Each of the second and third salts has an anion with a different chemical composition than the DFOB or BOB salt; however, the cations of the second and third salts are the same as the cations of the DFOB or BOB salt. If the electrolyte comprises a second salt and a third salt, the second salt comprises an anion with a different chemical composition than an anion of the third salt. A concentration of the second salt, or a combined concentration of the second and third salts, is 30 mol % to 70 mol % of the total molar concentration of the salts in the solution. In some examples, the DFOB or BOB salt and the second salt are present in equimolar concentrations. In certain examples, the DFOB or BOB salt and each of the second and third salts are present in equimolar concentrations. In any of the foregoing or following embodiments, the total molar concentration of (i) the DFOB or BOB salt, (ii) the DFOB or BOB salt and the second salt, or (iii) the DFOB or BOB salt, the second salt, and the third salt in the solution may be 0.5 M to 5 M, such as 0.5 M to 4 M, 0.5 M to 3 M, 0.5 M to 2 M, 0.7 M to 1.5 M, or 0.8 M to 1.2 M. In certain examples, the total molar concentration is 1 M.

In certain embodiments, (i) the DFOB or BOB salt, (ii) the DFOB or BOB salt and the second salt, or (iii) the DFOB or BOB salt, the second salt, and the third salt are the only salts in the nonflammable electrolyte, other than additives which may be present in an amount of greater than zero and less than or equal to 5 wt %. The second and third salts, if present, may comprise any anion disclosed above. In certain embodiments, the anions of the second and third salts are selected from FSI⁻, TFSI⁻, BOB⁻, DFOB⁻, PO₂F₂⁻, PF₆⁻, BF₄⁻, and ClO₄⁻.

In some embodiments, the nonflammable electrolyte is intended for use in a lithium metal battery, and each of the salts comprises lithium cations. In some embodiments, the nonflammable electrolyte is intended for use in a sodium metal battery, and each of the salts comprises sodium cations. In some embodiments, the nonflammable electrolyte is intended for use in a potassium metal battery, and each of the salts comprises potassium cations.

In any of the foregoing or following embodiments, the nonflammable electrolyte may comprise LiBOB or LiDFOB. In some embodiments, the nonflammable electrolyte comprises a second lithium salt and, optionally, a third lithium salt. In certain implementations, the second salt and third salt, if present, are selected from LiFSI, LiTFSI, LiBOB, LiDFOB, LiPO₂F₂, LiPF₆, LiBF_{4,} and LiClO₄.

In any of the foregoing or following embodiments, the nonflammable electrolyte may comprise NaBOB or NaDFOB. In some embodiments, the nonflammable electrolyte comprises a second sodium salt and, optionally a third sodium salt. In certain implementations, the second salt and third salt, if present, are selected from NaFSI, NaTFSI, NaBOB, NaDFOB, NaPO₂F₂, NaPF₆, NaBF₄, or NaClO₄.

In any of the foregoing or following embodiments, the nonflammable electrolyte may comprise KBOB or KDFOB. In some embodiments, the nonflammable electrolyte comprises a second potassium salt and, optionally a third potassium salt. In certain implementations, the second salt and third salt, if present, are selected from KFSI, KTFSI, KBOB, KDFOB, KPO₂F₂, KPF₆, KBF₄, or KClO₄.

In any of the foregoing or following embodiments, the flame retardant compound may comprise TEP, and the cosolvent may comprise EC. In some embodiments, the nonflammable electrolyte comprises, consists essentially of, or consists of the DFOB or BOB salt, TEP, and EC. In some implementations, the nonflammable electrolyte comprises, consists essentially of, or consists of the DFOB or BOB salt, the second salt, TEP, and EC. In some implementations, the nonflammable electrolyte comprises, consists essentially of, or consists of the DFOB or BOB salt, the second salt, the third salt, TEP, and EC. In certain embodiments, the second salt and third salt, if present, each comprises an anion selected from FSI⁻, TFSI⁻, BOB⁻, DFOB⁻, PO₂F₂⁻, PF₆⁻, BF₄⁻, and ClO₄⁻. The second and third salts each comprise an anion having a different chemical composition than an anion of the DFOB or BOB salt. If three salts are present, the second and third salts comprise different anions from one another.

In one embodiment, the nonflammable electrolyte comprises, consists essentially of, or consists of TEP, EC, and LiDFOB or LiBOB. In an independent embodiment, the nonflammable electrolyte comprises, consists essentially of, or consists of TEP, EC, LiDFOB, and the second salt, wherein the second salt is LiFSI, LiTFSI, LiBOB, LiPO₂F_{2,} LiPF_{6,} LiBF_{4,} or LiClO_{4.} In another independent embodiment, the nonflammable electrolyte comprises, consists essentially of, or consists of TEP, EC, LiBOB, and the second salt, wherein the second salt is LiFSI, LiTFSI, LiDFOB, LiPO₂F_{2,} LiPF_{6,} LiBF_{4,} or LiClO_{4.} In any of the foregoing or following embodiments, solvent may comprise 60 vol % to 80 vol % TEP and 20 vol % to 40 vol % EC, such as 65 vol % to 70 vol % TEP and 30 vol % to 35 vol % EC. In some embodiments, when the nonflammable electrolyte includes the second salt, the LiDFOB or LiBOB and the second salt are present in equimolar amounts.

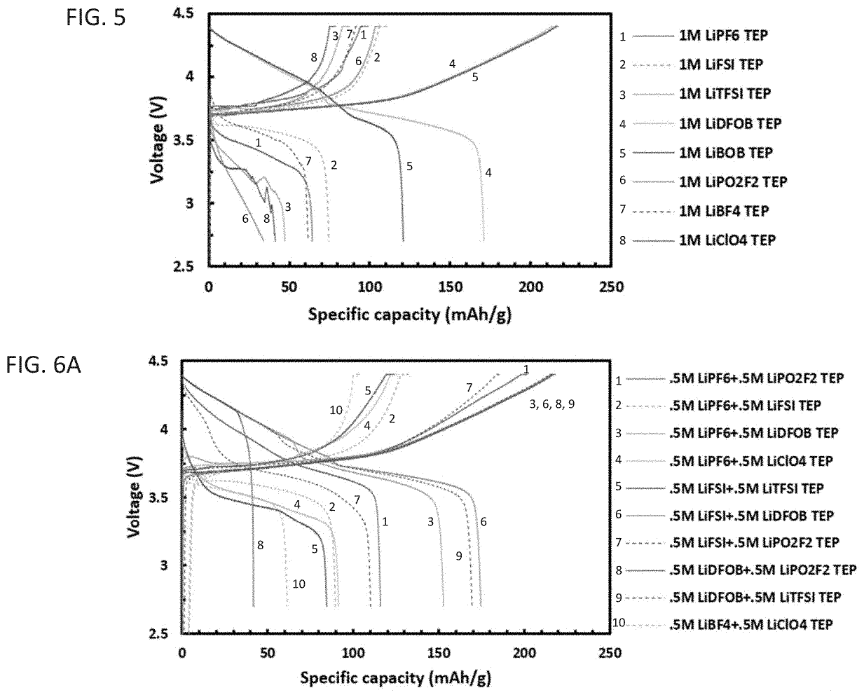

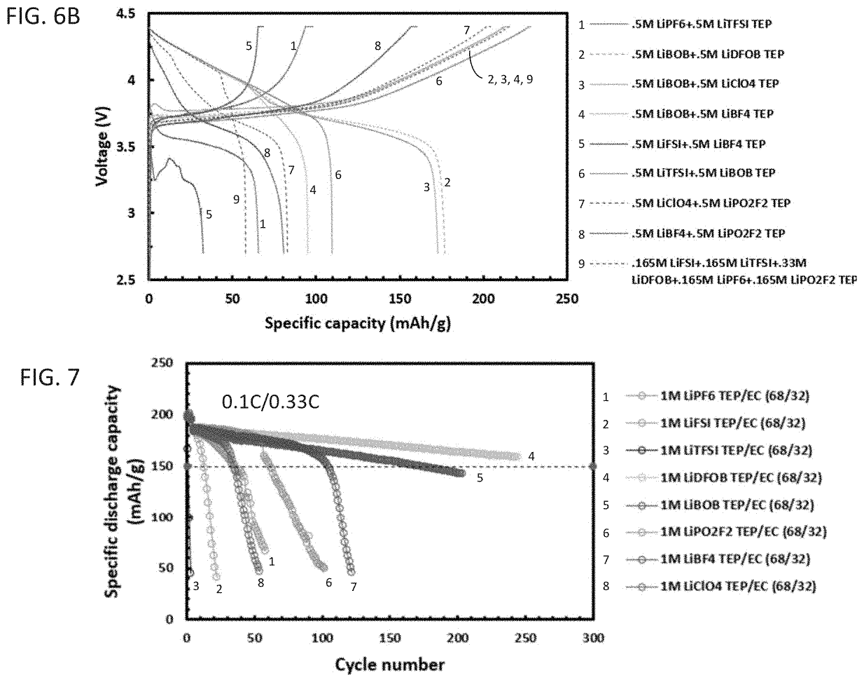

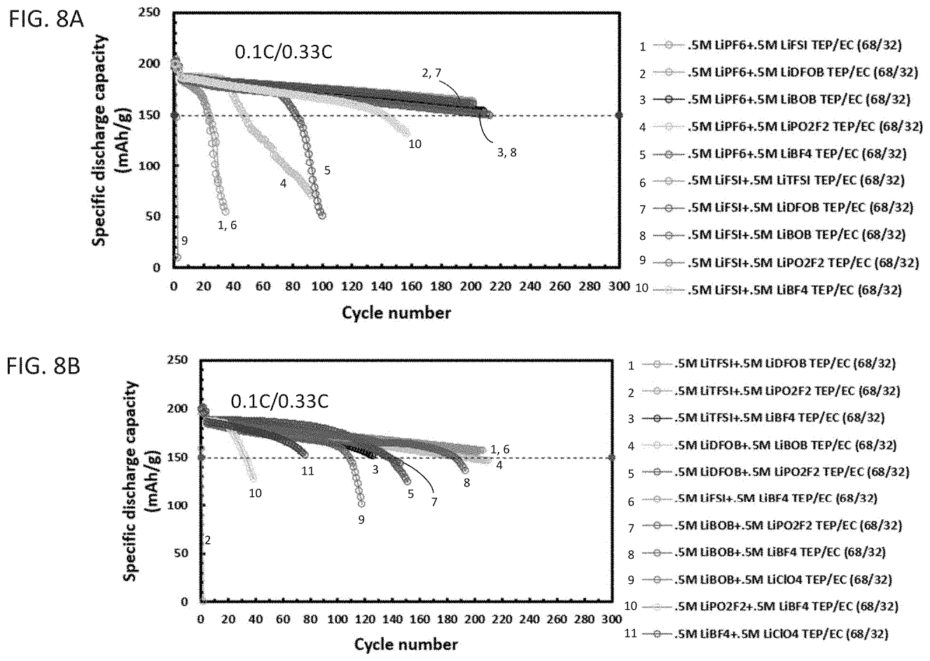

Some nonflammable electrolytes comprising LiDFOB or LiBOB, optionally a second salt, and a solvent comprising 60 vol % to 90 vol % of a flame retardant compound comprising an organic phosphate and 10 vol % to 40 vol % of a cosolvent comprising an organic carbonate solvent provided an increased cycle life and/or increased stability (e.g., as evidenced by capacity retention and/or reduced gas byproduct generation) during use compared to a similar nonflammable electrolyte comprising a single salt or dual salts in TEP alone or to a similar nonflammable electrolyte comprising a single salt or dual salts in TEP/EC wherein the electrolyte does not include LiDFOB or LiBOB. For example, several electrolytes comprising a single salt or dual salts in TEP failed to deliver a normal capacity (˜200 mAh/g) even at the first formation cycle at 0.03C (FIGS. 5, 6A-B). Additionally, several electrolytes comprising a single salt or dual salts in TEP/EC (68/32 by volume) wherein neither of the salts was LiDFOB or LiBOB failed after fewer than 150 cycles or fewer than 100 cycles, as evidenced by a capacity retention of less than 80% (FIGS. 7, 8A-B). In contrast, an electrolyte comprising 1 M LiDFOB in TEP/EC had a capacity retention of 85% after 240 cycles, and an electrolyte comprising 1 M LiBOB in TEP/EC had a capacity retention of 80% after 180 cycles. An electrolyte comprising LiDFOB and LiPF₆ in TEP/EC exhibited a capacity retention of ˜88% after 200 cycles.

Exemplary nonflammable electrolytes include, but are not limited to, 1 M LiDFOB in TEP/EC (68/32 by volume), 1 M LiBOB in TECP/EC (68/32 by volume), 1 M LiFSI/LiDFOB (1/1 molar ratio) in TEP/EC (68/32 by volume), 1 M LiTFSI/LiDFOB (1/1 molar ratio) in TEP/EC (68/32 by volume), 1 M LiDFOB/LiPO₂F₂/LiBOB (1/1/1 molar ratio) in TEP/EC (68/32 by volume), LiBOB/LiPO₂F₂/LiPF₆ (1/1/1 molar ratio) in TEP/EC (68/32 by volume), and LiBOB/LiP₂F₂/LiClO₄ (1/1/1 molar ratio) in TEP/EC (68/32 by volume).

### C. Additives

In any of the foregoing or following embodiments, the nonflammable electrolyte may further comprise one or more additives. Each additive may be present in an amount of greater than zero and less than or equal to 5 wt %, such as from 0.001 wt % to 5 wt %, 0.01 wt % to 5 wt %, 0.05 wt % to 4 wt %, 0.1 wt % to 3 wt %, or 0.5 wt % to 2 wt %. In some embodiments, a total amount of additives in the nonflammable electrolyte is 0 wt % to 5 wt %, such as 0 wt % to 4 wt %, 0 wt % to 3 wt %, 0 wt % to 2.5 wt %, 0.001 wt % to 2.5 wt %, or 0.01 wt % to 2.5 wt %. In some embodiments, the additive comprises a fluorinated cyclic carbonate compound, an unsaturated cyclic carbonate compound, an organic phosphite compound, an amine, an imide, a sultone, a cyclic sulfate, a nitrate, or any combination thereof. The additive is not the same as the cosolvent or any of the at least four different salts of the nonflammable electrolyte. Exemplary additives include, but are not limited to, fluoroethylene carbonate (FEC), difluoroethylene carbonate (DFEC), or a combination thereof; vinylene carbonate (VC), vinyl ethylene carbonate (VEC), 4-methylene ethylene carbonate (MEC), 4,5-dimethylene ethylene carbonate (DMEC), tris(trimethylsilyl)phosphite (TTMSPi), N-(trimethylsilyl)diethylamine (TMSDEA), 1,3-propane sultone (PS), 1,3,2-dioxathiolane 2,2-dioxide (DTD, 1,2-ethylene sulfate), LiFSI, LiNO_{3,} or a combination thereof. In some embodiments, the additive is LiNO₃. In one example, the additive was 1 wt % LiNO₃.

### III. Batteries

Embodiments of the disclosed nonflammable electrolytes are useful in batteries (e.g., rechargeable batteries), sensors, and supercapacitors. Suitable batteries include, but are not limited to, lithium metal batteries, lithium ion batteries, lithium-sulfur batteries, lithium-oxygen batteries, lithium-air batteries, sodium metal batteries, sodium ion batteries, sodium-sulfur batteries, sodium-oxygen batteries, sodium-air batteries, potassium metal batteries, and potassium ion batteries.

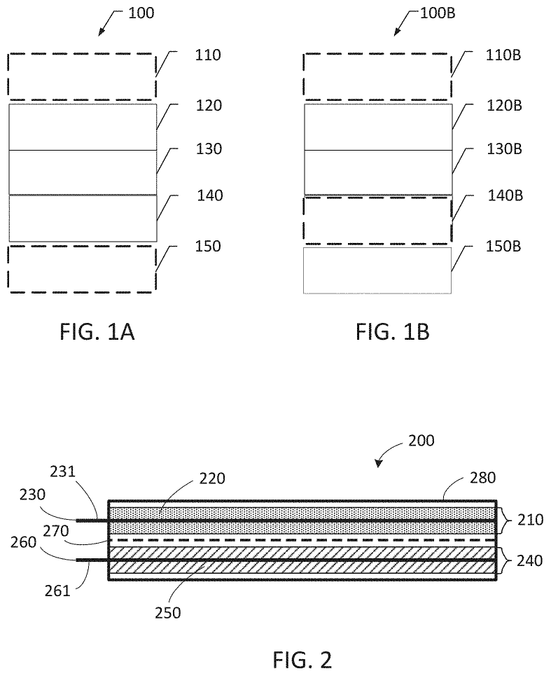

In some embodiments, a rechargeable battery comprises a nonflammable electrolyte as disclosed herein, a cathode, an anode, and optionally a separator. FIG. 1A is a schematic diagram of one exemplary embodiment of a rechargeable battery 100 including a cathode 120, a separator 130 which is infused with a nonflammable electrolyte as disclosed herein, and an anode 140. In some embodiments, the battery 100 also includes a cathode current collector 110 and/or an anode current collector 150.

In certain embodiments, a rechargeable battery is anode-free. As shown in FIG. 1B, the anode-free rechargeable battery 100B includes a cathode 120B, a separator 130B which is infused with a nonflammable electrolyte as disclosed herein, and an anode current collector 150B. In some embodiments, the battery also includes a cathode current collector 110B. In some embodiments, the cathode 120B is a Li-, Na-, or K-containing cathode, which serves as a metal source during a charging process of the battery. During the charging process of the battery 100B, an anode 140B comprising lithium, sodium, or potassium metal is formed in situ on the surface of the anode current collector 150B facing the separator 130B. By “in situ” is meant that the anode forms during a charging process of the battery. The anode active material 140B is at least partially consumed during a discharging process of the battery 100B. In other words, Li, Na, or K metal deposited onto the current collector 150B to form an anode 140B during charging is oxidized during discharge to produce Li⁺, Na⁺, or K⁺ cations. In some embodiments of an anode-free rechargeable battery, all or substantially all (e.g., at least 90 wt % or at least 95 wt %) of the anode active material is consumed during the discharging process. In an assembled state having charge, the rechargeable battery 100B comprises an anode current collector 150B, a cathode 120B, a separator 130B, an electrolyte as disclosed herein (not shown), and an in situ-formed anode on a surface of the anode current collector 150B facing the separator 130B. In an assembled uncharged state, the rechargeable battery 100B comprises the anode current collector 150B, the cathode 120B, the separator 130B, and the electrolyte (not shown). In the assembled uncharged state, the rechargeable battery 100B does not comprise an anode.

In some embodiments the rechargeable battery is a pouch cell. FIG. 2 is a schematic side elevation view of one embodiment of a simplified pouch cell 200. The pouch cell 200 comprises an anode 210 comprising anode material 220 (e.g., lithium metal, sodium metal, potassium metal, an intercalation material, or a conversion compound) and an anode current collector 230, a cathode 240 comprising cathode material 250 and a cathode current collector 260, a separator 270, and a packaging material defining a pouch 280 enclosing the anode 210, cathode 240, and separator 270. The pouch 280 further encloses a nonflammable electrolyte as disclosed herein (not shown). The anode current collector 230 has a protruding tab 231 that extends external to the pouch 280, and the cathode current collector 260 has a protruding tab 261 that extends external to the pouch 280. In certain implementations, the pouch cell 200 is anode-free in an uncharged state. In such implementations, the pouch cell 200 does not include the anode material 220 in the assembled uncharged state; only the anode current collector 230 is present. The anode material 220 is formed in situ on a surface of the anode current collector 230 facing the separator 270 during a charging process of the assembled pouch cell. The anode material 220 is at least partially consumed during the discharging process.

The current collectors can be a metal or another conductive material such as, but not limited to, nickel (Ni), copper (Cu), aluminum (Al), iron (Fe), stainless steel, or conductive carbon materials. The current collector may be a foil, a foam, or a polymer substrate coated with a conductive material. Advantageously, the current collector is stable (i.e., does not corrode or react) when in contact with the anode or cathode and the nonflammable electrolyte in an operating voltage window of the battery. The anode and cathode current collectors may be omitted if the anode or cathode, respectively, are free standing, e.g., when the anode is metal or a free-standing film comprising an intercalation material or conversion compound, and/or when the cathode is a free-standing film. By “free-standing” is meant that the film itself has sufficient structural integrity that the film can be positioned in the battery without a support material.

In some embodiments, the anode is a metal (e.g., lithium, sodium, or potassium), an intercalation material, or a conversion compound. The intercalation material or conversion compound may be deposited onto a substrate (e.g., a current collector) or provided as a free-standing film, typically, including one or more binders and/or conductive additives. Suitable binders include, but are not limited to, polyvinyl alcohol, polyvinyl chloride, polyvinyl fluoride, ethylene oxide polymers, polyvinylpyrrolidone, polyurethane, polytetrafluoroethylene, polyvinylidene fluoride, polyethylene, polypropylene, styrene-butadiene rubber, epoxy resin, nylon, and the like. Suitable conductive additives include, but are not limited to, carbon black, acetylene black, Ketjen black, carbon fibers (e.g., vapor-grown carbon fiber), metal powders or fibers (e.g., Cu, Ni, Al), and conductive polymers (e.g., polyphenylene derivatives).

Exemplary anodes for lithium batteries include, but are not limited to, Li, Mo₆S₈, TiO₂, V₂O₅, Li₄Mn₅O₁₂, Li₄Ti₅O₁₂, C/S composites, Si, C/Si composites, polyacrylonitrile (PAN)-sulfur composites, and anode free battery, e.g., directly use Cu foil as current collector and no active anode materials on it. In some embodiments, the anode is Li metal. Exemplary anodes for sodium batteries include, but are not limited to Na, NaTi₂(PO₄)₃, TiS₂, CuS, FeS₂, NiCo₂O₄, Cu₂Se, and Li_{0.5}Na_{0.5}Ti₂(PO₄)₃. In some embodiments, the anode is Na metal. Exemplary anodes for potassium batteries include, but are not limited to, K, carbon (e.g., graphite, carbon black, activated carbon, graphene), K₂Ti₄O₉, K₂Ti₈O₁₇, KTi₂(PO₄)₃/C, TiSe₂, MoS₂, CoS, Co₃O₄⁻ Fe₂O₃/C, VSe₂, dipotassium terephthalate, and 2,5-pyridinedicarboxylate. In some embodiments, the anode is potassium metal.

Exemplary cathode materials for lithium batteries include, but are not limited to, Li-rich Li_{1+w}NiₓMn_{y}Co_{z}O₂(x+y+z+w=1, 0≤w≤0.25), LiNiₓMn_{y}Co_{z}O₂ (NMC, x+y+z=1), LiCoO₂, LiNi_{0.8}Co_{0.15}Al_{0.05}O₂ (NCA), LiNi_{0.5}Mn_{1.5}O₄ spinel, LiMn₂O₄ (LMO), LiFePO₄ (LFP), Li₄₋ₓMₓTi₅O₁₂ (M=Mg, Al, Ba, Sr, or Ta; 0≤x≤1), MnO₂, V₂O₅, V₆O₁₃, LiVₑO₈, LiM^{C1}ₓM^{C2}₁₋ₓPO₄ (M^{C1} or M^{C2}=Fe, Mn, Ni, Co, Cr, or Ti; 0≤x≤1), Li₃V₂₋ₓM¹ₓ(PO₄)₃ (M¹=Cr, Co, Fe, Mg, Y, Ti, Nb, or Ce; 0≤x≤1), LiVPO₄F, LiM^{C1}ₓM^{C2}₁₋ₓO₂ ((M^{C1} and M^{C2} independently are Fe, Mn, Ni, Co, Cr, Ti, Mg, or Al; 0≤x≤1), LiM^{C1}ₓM^{C2}_{y}M^{C3}_{1-x-y}O₂ ((M^{C1}, M^{C2}, and M^{C3} independently are Fe, Mn, Ni, Co, Cr, Ti, Mg, or Al; 0≤x≤1; 0≤y≤1), LiMn_{2-y}X_{y}O₄ (X=Cr, Al, or Fe, 0≤y≤1), LiNi_{-.5-y}X_{y}Mn_{1.5}O₄ (X=Fe, Cr, Zn, Al, Mg, Ga, V, or Cu; 0≤y<0.5), xLi₂MnO₃·(1-x)LiM^{C1}_{y}M^{C2}_{z}M^{C3}_{1-y-z}O₂ (M^{C1}, M^{C2}, and M^{C3} independently are Mn, Ni, Co, Cr, Fe, or mixture thereof; x=0.3−0.5; y≤0.5; z≤0.5), Li₂M²SiO₄ (M²=Mn, Fe, or Co), Li₂M²SO₄ (M²=Mn, Fe, or Co), LiM²SO₄F (M²=Fe, Mn, or Co), Li₂₋ₓ(Fe_{1-y}Mn_{y})P₂O₇ (0≤y≤1), Cr₃O₈, Cr₂O₅, a carbon/sulfur composite, or an air electrode (e.g., a carbon-based electrode comprising graphitic carbon and, optionally, a metal catalyst such as Ir, Ru, Pt, Ag, or Ag/Pd). In an independent embodiment, the cathode may be a lithium conversion compound, such as Li₂O₂, Li₂S, or LiF.

Exemplary cathode materials for sodium batteries include, but are not limited to, NaFePO₄, Na₂FePO₄F, Na₂Fe₂O₇, Na₃V₂(PO)₃, Na₃V₂(PO₄)₂F₃, NaVPO₄F, NaVOPO₄F, Na_{1.5}VOPO₄F_{0.5}, NaCo₂O₄, Na₂Ti₃O₇, and NaₓMO₂ where 0.4<x≤1, and M is a transition metal or a mixture of transition metals (e.g., NaCrO₂, NaCoO₂, NaₓCoO₂ (0.4≤x≤0.9), Na_{2/3}Ni_{1/3}Mn_{2/3}O₂, Na_{2/3}Fe_{1/2}Mn_{1/2}O₂, Na_{2/3}Ni_{1/6}Co_{1/6}Mn_{2/3}O₂, NaNi_{1/3}Fe_{1/3}Mn_{1/3}O₂, NaNi_{1/3}Fe_{1/3}Co_{1/3}O₂, NaNi_{1/2}Mn_{1/2}O₂, Prussian white analogue cathodes (e.g., Na₂MnFe(CN)₆ and Na₂Fe₂(CN)₆), Prussian blue analogue (PBA) cathodes (Na₂₋ₓMₐ[M_{b}(CN)₆]_{1-y}·nH₂O, wherein Mₐ and M_{b} independently are Fe, Co, Ni, or Cu, x=0 to 0.2, y=0 to 0.2, n=1 to 10). Other sodium intercalation materials include Na₄Ti₅O₁₂, Fe₃O₄, TiO₂, Sb₂O₄, Sb/C composite, SnSb/C composite, BiSb/C composite, and amorphous P/C composite. In an independent embodiment, the cathode is a sodium conversion compound in which sodium displaces another cation, such as FeSe, CuWO₄, CuS, CuO, CuCl, or CuCl₂.

Exemplary cathode materials for potassium batteries include, but are not limited to, Prussian blue, Prussian blue analogues, K_{0.5}MnO₂, K_{0.55}CoO₂, K_{0.48}Mn_{0.4}Co_{0.6}O₂, K_{0.85}Fe_{0.5}Mn_{0.5}O₂, K₃V₂(PO₄)₃, KVPO₄F. potassium ferro/ferricyanide, potassium cobalt oxide (e.g., K_{0.6}CoO₂).

The separator may be glass fiber, a porous polymer film (e.g., polyethylene- or polypropylene-based material) with or without a ceramic coating, or a composite (e.g., a porous film of inorganic particles and a binder). One exemplary polymeric separator is a Celgard® K1640 polyethylene (PE) membrane. Another exemplary polymeric separator is a Celgard® 2500 polypropylene membrane. Another exemplary polymeric separator is a Celgard® 3501 surfactant-coated polypropylene membrane. The separator may be infused with an electrolyte, as disclosed herein.

In some embodiments, a rechargeable battery includes a lithium metal anode, a cathode suitable for a lithium battery as disclosed above, a separator, and a nonflammable electrolyte as disclosed herein. The rechargeable battery may be a pouch cell. Each of the salts comprises lithium cations. Exemplary lithium-based salts include, but are not limited to, LiFSI, LiTFSI, LiBETI, LiBOB, LiPF₆, LiAsF₆, LiBF₄, CF₃SO₃Li, LiClO₄, LiDFOB, LiPO₂F₂, Lil, LiBr, LiCl, LiSCN, LiNO₃, LiNO₂, Li₂SO₄, and combinations thereof. In some embodiments, the electrolyte comprises at least four different lithium salts and a solvent comprising a flame retardant compound and, optionally, a cosolvent. In some implementations, the electrolyte comprises four or five different lithium salts selected from LiFSI, LiTFSI, LiDFOB, LiBOB, LiPF₆, and LiPO₂F₂. In certain embodiments, LiDFOB or LiBOB is the primary salt, and the electrolyte comprises LiDFOB or LiBOB in a molar concentration that is greater than a molar concentration of any other single salt in the nonflammable electrolyte and is ≤70 mol % of a total molar concentration of the at least four salts. In any of the foregoing or following embodiments, the flame retardant compound may comprise an organic phosphate, an organic phosphite, an organic phosphonate, an organic phosphoramide, a phosphazene, or any combination thereof, as previously discussed. In some embodiments, the flame retardant compound comprises TEP. In any of the foregoing or following embodiments, the electrolyte may further comprise a cosolvent. In some embodiments, the cosolvent comprises EC. In some embodiments, the electrolyte comprises LiDFOB or LiBOB, optionally a second salt, and a solvent comprising a flame retardant compound comprising an organic phosphate and a cosolvent comprising an organic carbonate solvent. In certain embodiments, the solvent comprises TEP and EC. In one implementation, a battery includes a lithium metal anode, a cathode suitable for a lithium battery as disclosed above, a separator, and a nonflammable electrolyte comprising, consisting essentially or, or consisting of LiFSI, LiTFSI, LiDFOB, LiPF₆, LiPO₂F₂, TEP, and EC. In an independent implementation, a battery includes a lithium metal anode, a cathode suitable for a lithium battery as disclosed above, a separator, and a nonflammable electrolyte comprising, consisting essentially or, or consisting of TEP, EC, LiDFOB or LiBOB, and optionally a second salt selected from LiPF₆, LiFSI, LiTFSI, LiClO₄, LiDFOB, LiBOB, LiPO₂F₂, and LiBF₄. In some embodiments, the cathode comprises LiNiₓMn_{y}Co_{z}O₂ (NMC), sulfur/carbon, or an air electrode.

In some embodiments, a rechargeable battery includes a sodium metal anode, a cathode suitable for a sodium battery as disclosed above, a separator, and a nonflammable electrolyte as disclosed herein. The rechargeable battery may be a pouch cell. Each of the at least four different salts comprises sodium cations. Exemplary sodium-based salts include, but are not limited to NaFSI, NaTFSI, NaBOB, NaDFOB, NaBETI, NaFAP, NaPF₆, NaAsF₆, NaCF₃SO₃, NaPO₂F₂, NaClO₄, NaBF₄, NaI, NaBr, NaCl, NaSCN, NaNO₃, NaNO₂, Na₂SO₄, and combinations thereof. In certain embodiments, NaDFOB or NaBOB is the primary salt, and the electrolyte comprises NaDFOB or NaBOB in a molar concentration that is greater than a molar concentration of any other single salt in the nonflammable electrolyte and is ≤70 mol % of a total molar concentration of the at least four salts. In any of the foregoing or following embodiments, the flame retardant compound may comprise an organic phosphate, an organic phosphite, an organic phosphonate, an organic phosphoramide, a phosphazene, or any combination thereof, as previously discussed. In some embodiments, the flame retardant compound comprises TEP. In any of the foregoing or following embodiments, the electrolyte may further comprise a cosolvent. In some embodiments, the cosolvent comprises EC. In some embodiments, the electrolyte comprises NaDFOB or NaBOB, optionally a second salt, and a solvent comprising a flame retardant compound comprising an organic phosphate and a cosolvent comprising an organic carbonate solvent. In certain embodiments, the solvent comprises TEP and EC. In one implementation, a battery includes a sodium metal anode, a cathode suitable for a sodium battery as disclosed above, a separator, and a nonflammable electrolyte comprising, consisting essentially or, or consisting of NaFSI, NaTFSI, NaDFOB, NaPF₆, NaPO₂F₂, TEP, and EC. In an independent implementation, a battery includes a sodium metal anode, a cathode suitable for a sodium battery as disclosed above, a separator, and a nonflammable electrolyte comprising, consisting essentially or, or consisting of TEP, EC, NaDFOB or NaBOB, and optionally a second salt selected from NaPF₆, NaFSI, NaTFSI, NaClO₄, NaDFOB, NaBOB, NaPO₂F₂, and LiBF₄. In certain embodiments, the cathode is Na₃V₂(PO₄)₃.

In some embodiments, a rechargeable battery includes a potassium metal anode, a cathode suitable for a potassium battery as disclosed above, a separator, and a nonflammable electrolyte as disclosed herein. The rechargeable battery may be a pouch cell. In some embodiments, each of the at least four different salts comprises potassium cations. Exemplary potassium-based salts include, but are not limited to KFSI, KTFSI, KBOB, KDFOB, KBETI, KFAP, KPF₆, KAsF₆, CF₃SO₃K, KPO₂F₂, KClO₄, KBF₄, KI, KBr, KCl, KSCN, KNO₃, KNO₂, K₂SO₄, and combinations thereof. In certain embodiments, KDFOB or KBOB is the primary salt, and the electrolyte comprises KDFOB or KBOB in a molar concentration that is greater than a molar concentration of any other salt in the nonflammable electrolyte and is ≤70 mol % of a total molar concentration of the at least four salts. In any of the foregoing or following embodiments, the flame retardant compound may comprise an organic phosphate, an organic phosphite, an organic phosphonate, an organic phosphoramide, a phosphazene, or any combination thereof, as previously discussed. In some embodiments, the flame retardant compound comprises TEP. In any of the foregoing or following embodiments, the electrolyte may further comprise a cosolvent. In some embodiments, the cosolvent comprises EC. In some embodiments, the electrolyte comprises KDFOB or KBOB, optionally a second salt, and a solvent comprising a flame retardant compound comprising an organic phosphate and a cosolvent comprising an organic carbonate solvent. In certain embodiments, the solvent comprises TEP and EC. In one implementation, a battery includes a potassium metal anode, a cathode suitable for a potassium battery as disclosed above, a separator, and a nonflammable electrolyte comprising, consisting essentially or, or consisting of KFSI, KTFSI, KDFOB, KPF₆, KPO₂F₂, TEP, and EC. In an independent implementation, a battery includes a potassium metal anode, a cathode suitable for a potassium battery as disclosed above, a separator, and a nonflammable electrolyte comprising, consisting essentially or, or consisting of TEP, EC, KDFOB or KBOB, and optionally a second salt selected from KPF₆, KFSI, KTFSI, KClO₄, KDFOB, KBOB, KPO₂F₂, and KBF₄. In certain embodiments, the cathode is K_{0.85}Fe_{0.5}Mn_{0.5}O₂

In some embodiments, a battery including a nonflammable electrolyte as disclosed herein has a CE≥95%, such as ≥96%, ≥97%, ≥98%, ≥99%, ≥99.5%, or even ≥99.9%. The CE may be, for example, 95-100%, 96-100%, 97-100%, 98-100%, 99-100%, 99.5-100%, or 99.9-100%. Embodiments of batteries including nonflammable electrolytes as disclosed herein demonstrate stable cycling performance (e.g., as evidenced by a stable CE and/or specific capacity) over a period of at least 100 cycles, at least 150 cycles, or at least 200 cycles In some embodiments, the battery has a capacity retention of at least 80% for at least 175 cycles, at least 200 cycles, or at least 250 cycles, and/or a capacity retention of at least 75% for at least 175 cycles, at least 200 cycles, at least 250 cycles, or even at least 300 cycles. For example, the battery may demonstrate stable cycling performance for 100-300 cycles, such as 175-300 cycles, 200-300 cycles, or 225-300 cycles.

In some embodiments, a pouch cell comprising a metal anode, a cathode, a separator, a packaging material, and a nonflammable electrolyte as disclosed herein, generates little or no gaseous byproduct during operation of the pouch cell for at least 200 cycles in an operating voltage window of the pouch cell. In certain examples, the voltage window is 2.7-4.4 V. In any of the foregoing embodiments, the nonflammable electrolyte may comprise 4-6 different salts with anions selected from FSI⁻, TFSI⁻, DFOB⁻, BOB⁻, PF₆⁻, and PO₂F₂⁻, and a solvent comprising 60-75 vol % of the flame retardant compound and 25 vol % to 40 vol % of a cosolvent comprising an organic carbonate solvent. Alternatively, in any of the foregoing embodiments, the nonflammable electrolyte may comprise a DFOB or BOB salt, and a solvent comprising 60-75 vol % of the flame retardant compound and 25 vol % to 40 vol % of a cosolvent comprising an organic carbonate solvent. The DFOB or BOB salt comprises 30 mol % to 100 mol % of the total molar concentration of salts in the electrolyte. In some embodiments, the DFOB or BOB salt comprises 95-100 mol % of the total molar concentration of salts in the electrolyte. The nonflammable electrolyte may further comprise a second salt, the second salt having a different anion than the DFOB or BOB salt, wherein cations of the second salt are the same as the cations of the DFOB or BOB salt and a concentration of the second salt is 30 mol % to 70 mol % of the total molar concentration of the salts in the solution. The anion of the second salt may be FSI⁻, TFSI⁻, BOB⁻, DFOB⁻, PO₂F₂⁻, PF₆⁻, BF₄⁻, or ClO₄⁻. In some implementations, the nonflammable electrolyte further comprises a second salt and a third salt, each of the second salt and third salt having a different anion than the DFOB or BOB salt, the second salt having an anion with a different chemical composition than an anion of the third salt, wherein cations of the second salt and third salt are the same as the cations of the DFOB or BOB salt and a combined concentration of the second salt and the third salt is 30 mol % to 70 mol % of the total molar concentration of the salts in the solution. The anions of the second salt and the third salt may be FSI⁻, TFSI⁻, BOB⁻, DFOB⁻, PO₂F₂⁻, PF₆⁻, BF₄⁻, or ClO₄⁻. In any of the foregoing embodiments, the flame retardant compound may comprise TEP and/or the cosolvent may comprise EC.

Synergistic effects arising from the combination of at least four different salts and/or the combination of a flame retardant compound and cosolvent (e.g., TEP and EC) may contribute to the superior electrochemical performance of electrochemical devices comprising certain embodiments of the disclosed nonflammable electrolytes, as evidenced by increased cycling stability compared to other nonflammable solvents with fewer than four different salts and/or without a cosolvent. In some embodiments, synergistic effects from the combination of a DFOB or BOB salt with a flame retardant compound comprising an organic phosphate and a cosolvent comprising an organic carbonate solvent contribute to the superior electrochemical performance of electrochemical devices comprising certain embodiments of the disclosed nonflammable electrolytes, as evidenced by increased cycling stability compared to other nonflammable solvents without a DFOB or BOB salt and/or without the combination of the organic phosphate and organic carbonate solvent. Advantageously, in some embodiments, the synergistic effects may include production of less gaseous byproduct during operation of the battery compared to a battery comprising the same anode, same cathode, and same separator, and a nonflammable electrolyte comprising the same solvent, but including fewer than four different salts. Gas generation is a serious problem during cycling of pouch cells including certain electrolytes. For example, electrolytes comprising LiDFOB and/or LiBOB are known to generate gaseous byproducts. However, as discussed above, the inventors surprisingly discovered that certain nonflammable electrolytes as disclosed herein generate less gas than a comparable electrolyte comprising the same solvent but fewer than four different salts, even when the salts include DFOB⁻ or BOB⁻ anions. Additionally, the inventors surprisingly discovered that certain nonflammable electrolytes including only one or two salts, wherein one of the salts includes DFOB⁻ or BOB⁻ anions, and the solvent comprises an organic phosphate and an organic carbonate solvent, exhibit superior performance compared to nonflammable electrolytes that do not include the organic carbonate solvent.

In summary, certain embodiments of the disclosed nonflammable electrolytes are safer than conventional, flammable electrolytes, are cost-effective, safe, provide high CE, and/or provide stable cycling of rechargeable batteries. Embodiments of the disclosed nonflammable electrolytes are useful with many battery types, such as lithium metal batteries, lithium ion batteries, lithium-sulfur batteries, lithium-oxygen batteries, lithium-air batteries, sodium metal batteries, sodium ion batteries, sodium-air batteries, sodium-sulfur batteries, sodium-oxygen batteries, potassium metal batteries, potassium ion batteries, potassium-air batteries, potassium-sulfur batteries, and potassium-oxygen batteries. In certain embodiments, the battery is a lithium metal, sodium metal, or potassium metal battery. The battery may be a pouch cell battery.

### IV. Representative Embodiments

Certain representative embodiments are exemplified in the following paragraphs.

A nonflammable electrolyte, comprising: a solution comprising
(a) at least four different salts, wherein (i) each salt comprises an anion with a different chemical composition than an anion of each of the other salts, (ii) cations of each of the salts are the same, the cations comprising lithium cations, sodium cations, or potassium cations, and (iii) a concentration of each of the salts is ≥5 mol % of a total molar concentration of the salts in the solution, and a solvent comprising >50 vol % to 100 vol % of a flame retardant compound and 0 vol % to 50 vol % of a cosolvent; or
(b) a difluoro(oxalato)borate (DFOB) or bis(oxalato)borate (BOB) salt comprising lithium cations, sodium cations, or potassium cations, wherein a concentration of the DFOB or BOB salt is 30 mol % to 100 mol % of a total molar concentration of salts in the solution, and a solvent comprising 60 vol % to 90 vol % of a flame retardant compound comprising an organic phosphate and 10 vol % to 40 vol % of a cosolvent comprising an organic carbonate solvent.

The nonflammable electrolyte of the preceding paragraph, wherein the total molar concentration of the salts in the solution is 0.5 M to 5 M. The nonflammable electrolyte of either of the foregoing paragraphs, wherein the solution comprises at least four different salts and each of the salts is present in an amount of at least 10 mol % of the total molar concentration of the salts.

The nonflammable electrolyte of any of the foregoing paragraphs, wherein the solution comprises 4-10 different salts. The nonflammable electrolyte of the foregoing paragraph, wherein each of the salts is present in an amount of from 10 mol % to 70 mol % of the total molar concentration of the salts.

The nonflammable electrolyte of any of the foregoing paragraphs, wherein the solution comprises at least four different salts and each salt comprises an anion selected from bis(fluorosulfonyl)imide (FSI⁻), bis(trifluoromethanesulfonyl)imide (TFSI⁻), bis(pentafluoroethanesulfonyl)imide (BETI⁻), bis(oxalato)borate (BOB⁻), difluoro(oxalato)borate (DFOB⁻), tris(pentafluoroethyl)trifluorophosphate (FAP⁻), PO₂F₂⁻, PF₆⁻, AsF₆⁻, BF₄⁻, CF₃SO₃⁻, ClO₄⁻, I, Br⁻, Cl⁻, SCN⁻, NO₃⁻, NO₂⁻, and SO₄²⁻.

The nonflammable electrolyte of the foregoing paragraph, wherein the nonflammable electrolyte comprises DFOB⁻ or BOB⁻ in a molar concentration that is greater than a molar concentration of any other anion in the nonflammable electrolyte and is ≤70 mol % of a total molar concentration of the anions of the salts in the solution.

The nonflammable electrolyte of either of the foregoing paragraphs, wherein the nonflammable electrolyte comprises 4-6 different salts comprising anions selected from FSI⁻, TFSI⁻, DFOB⁻, BOB⁻, BF₄⁻, PF₆⁻, and PO₂F₂⁻.

The nonflammable electrolyte of any of the foregoing paragraphs, consisting essentially of: the salts; the solvent; and the cosolvent, if present.

The nonflammable electrolyte of either of the first two paragraphs, wherein the concentration of the DFOB or BOB salt is 30 mol % to 70 mol % of the total molar concentration of the salts in the solution, and the solution further comprises: a second salt, the second salt having an anion with a different chemical composition than an anion of the DFOB or BOB salt, wherein cations of the second salt are the same as the cations of the DFOB or BOB salt and a concentration of the second salt is 30 mol % to 70 mol % of the total molar concentration of the salts in the solution; or a second salt and a third salt, each of the second and third salts having anions with a different chemical composition than the anion of the DFOB or BOB salt, and the second salt having an anion with a different chemical composition than the anion of the third salt, wherein cations of the second and third salts are the same as the cations of the DFOB or BOB salt and a combined concentration of the second and third salts is 30 mol % to 70 mol % of the total molar concentration of the salts in the solution.

The nonflammable electrolyte of the foregoing paragraph, wherein: the anion of the second salt is bis(fluorosulfonyl)imide (FSI⁻), bis(trifluoromethanesulfonyl)imide (TFSI⁻), bis(oxalato)borate (BOB⁻), difluoro(oxalato)borate (DFOB⁻), PO₂F₂⁻, PF₆⁻, BF₄⁻, or ClO₄⁻; or the anions of the second salt and the third salt are FSI⁻, TFSI⁻, BOB⁻, DFOB⁻, PO₂F₂⁻, PF₆⁻, BF₄⁻, or ClO₄⁻. Or, the nonflammable electrolyte of the foregoing paragraph, comprising: TEP, EC, LiDFOB or LiBOB, and the second salt, wherein the second salt comprises LiPF₆, LiFSI, LiTFSI, LiClO₄, LiDFOB, LiBOB, LiPO₂F₂, or LiBF₄; or TEP, EC, LiDFOB or LiBOB, the second salt, and the third salt, wherein each of the second and third salts comprises LiPF₆, LiFSI, LiTFSI, LiClO₄, LiDFOB, LiBOB, LiPO₂F₂, or LiBF₄.

The nonflammable electrolyte of any of the first two paragraphs or the preceding two paragraphs, consisting essentially of: the DFOB or BOB salt; the second salt, if present; the third salt, if present; the flame retardant compound; and the cosolvent. The nonflammable electrolyte of any of the foregoing paragraphs, wherein the flame retardant compound comprises an organic phosphate, an organic phosphite, an organic phosphonate, an organic phosphoramide, a phosphazene, or any combination thereof.

The nonflammable electrolyte of the foregoing paragraph, wherein the flame retardant compound comprises triethyl phosphate (TEP), trimethyl phosphate (TMP), tributyl phosphate, triphenyl phosphate, tris(2,2,2-trifluoroethyl) phosphate, bis(2,2,2-trifluoroethyl) methyl phosphate, triphenyl phosphite, tris(2,2,2-trifluoroethyl) phosphite; dimethyl methylphosphonate, diethyl ethylphosphonate, diethyl phenylphosphonate, bis(2,2,2-trifluoroethyl) methylphosphonate; hexamethylphosphoramide; hexamethoxyphosphazene, hexafluorophosphazene, or any combination thereof.

The nonflammable electrolyte of any of the foregoing paragraphs, wherein the cosolvent comprises an organic carbonate solvent, an ether solvent, an organic sulfoxide, a sulfone, an organic nitrogen-containing solvent, or any combination thereof.

The nonflammable electrolyte of the foregoing paragraph, wherein the cosolvent comprises ethylene carbonate (EC), dimethyl carbonate (DMC), vinylene carbonate (VC), fluoroethylene carbonate (FEC), difluoroethylene carbonate (DFEC), trifluoroethylene carbonate (TFEC), vinyl ethylene carbonate (VEC), 4-methylene ethylene carbonate (MEC), propylene carbonate (PC), ethyl methyl carbonate (EMC), diethyl carbonate (DEC), methyl 2,2,2-trifluoroethyl carbonate (MFEC), dimethoxyethane (DME), 1,3-dioxolane (DOL), tetrahydrofuran (THF), allyl ether, dimethyl sulfoxide (DMSO), dimethyl sulfone (DMS), ethyl methyl sulfone (EMS), ethyl vinyl sulfone (EVS), tetramethylene sulfone (TMS), trifluoromethyl ethyl sulfone (FMES), trifluoromethyl isopropyl sulfone (FMIS), trifluoropropyl methyl sulfone (FPMS), diethylene glycol dimethyl ether (diglyme), triethylene glycol dimethyl ether (triglyme), tetraethylene glycol dimethyl ether (tetraglyme), methyl butyrate, ethyl propionate, gamma-butyrolactone, acetonitrile (AN), succinonitrile (SN), adiponitrile, triallyl amine, triallyl cyanurate, triallyl isocyanurate, or any combination thereof. The nonflammable electrolyte of any of the foregoing paragraphs, wherein: (i) the flame retardant compound comprises TEP; or (ii) the cosolvent comprises EC; or (iii) both (i) and (ii).

The nonflammable electrolyte of the first paragraph, comprising: LiFSI, LiTFSI, LiDFOB, LiPF₆, and LiPO₂F₂; TEP; and EC.

The nonflammable electrolyte of the foregoing paragraph, consisting essentially of the LiFSI, LiTFSI, LiDFOB, LiPF₆, LiPO₂F₂, TEP, and EC.

The nonflammable electrolyte of either of the foregoing paragraphs, wherein: (i) the LiFSI, LiTFSI, LiDFOB, LiPF₆, and LiPO₂F₂ are present in a molar ratio of 1:1:2:1:1, 1:1:3:1:1, or 1:1:4:1:1; or (ii) the EC is present in an amount of 30-35 vol % of a combined volume of the TEP and the EC; or (iii) both (i) and (ii).

The nonflammable electrolyte of the first paragraph, comprising: LiDFOB or LiBOB, wherein the concentration of the LiDFOB or LiBOB is 40 mol % to 100 mol % of the total molar concentration of salts in the solution; TEP; and EC.

A battery system, comprising: the nonflammable electrolyte according to any of the foregoing paragraphs; a cathode; and an anode current collector in the absence of an anode, or an anode comprising lithium metal, sodium metal, potassium metal, an intercalation material, or a conversion compound.

The battery system of the foregoing paragraph, wherein: the anode comprises lithium metal; and the cathode comprises Li_{1+w}NiₓMn_{y}Co_{z}O₂(x+y+z+w=1, 0≤w≤0.25), LiNiₓMn_{y}Co_{z}O₂ (x+y+z=1), LiNi_{0.8}Co_{0.15}Al_{0.05}O₂ LiCoO₂, LiNi_{0.5}Mn_{1.5}O₄ spinel, LiMn₂O₄, LiFePO₄, Li₄₋ₓMₓTi₅O₁₂ (M=Mg, Al, Ba, Sr, or Ta; 0≤x≤1), MnO₂, V₂O₅, V₆O₁₃, LiVₑO₈, LiM^{C1}ₓM^{C2}₁₋ₓPO₄ (M^{C1} or M^{C2}=Fe, Mn, Ni, Co, Cr, or Ti; 0≤x≤1), Li₃V₂₋ₓM¹ₓ(PO₄)₃ (M¹=Cr, Co, Fe, Mg, Y, Ti, Nb, or Ce; 0≤x≤1), LiVPO₄F, LiM^{C1}ₓM^{C2}₁₋ₓO₂ ((M^{C1} and M^{C2} independently are Fe, Mn, Ni, Co, Cr, Ti, Mg, or Al; 0≤x≤1), LiM^{C1}ₓM^{C2}_{y}M^{C3}_{1-x-y}O₂ ((M^{C1}, M^{C2}, and M^{C3} independently are Fe, Mn, Ni, Co, Cr, Ti, Mg, or Al; 0≤x≤1; 0≤y≤1), LiMn_{2-y}X_{y}O₄ (X=Cr, Al, or Fe, 0≤y≤1), LiNi_{-.5-y}X_{y}Mn_{1.5}O₄ (X=Fe, Cr, Zn, Al, Mg, Ga, V, or Cu; 0≤y<0.5), xLi₂MnO₃·(1-x)LiM^{C1}_{y}M^{C2}_{z}M^{C3}_{1-y-z}O₂ (M^{C1}, M^{C2}, and M^{C3} independently are Mn, Ni, Co, Cr, Fe, or mixture thereof; x=0.3−0.5; y≤0.5; z≤0.5), Li₂M²SiO₄ (M²=Mn, Fe, or Co), Li₂M²SO₄ (M²=Mn, Fe, or Co), LiM²SO₄F (M²=Fe, Mn, or Co), Li₂₋ₓ(Fe_{1-y}Mn_{y})P₂O₇ (0≤y≤1), Cr₃O₈, Cr₂O₅, a carbon/sulfur composite, or an air electrode.

The battery system of either of the foregoing paragraphs, wherein the battery system is a pouch cell comprising: the anode current collector in the absence of the anode, or the anode, wherein the anode comprises lithium metal, sodium metal, or potassium metal; the cathode; a separator; the nonflammable electrolyte; and a packaging material defining a pouch enclosing the anode, the cathode, the separator, and the nonflammable electrolyte.

The battery system of any of the foregoing paragraphs, wherein: the nonflammable electrolyte comprises 4-6 different salts; the anions are selected from FSI⁻, TFSI⁻, DFOB⁻, BOB⁻, PF₆⁻, and PO₂F⁻; and the solvent comprises 60-75 vol % of the flame retardant compound and 25 vol % to 40 vol % of a cosolvent comprising an organic carbonate solvent.

The battery system of any of the foregoing paragraphs, wherein: the solution comprises a difluoro(oxalato)borate (DFOB) or bis(oxalato)borate (BOB) salt, wherein a concentration of the DFOB or BOB salt is 40 mol % to 100 mol % of a total molar concentration of salts in the solution; and the solvent comprises 60-75 vol % of the flame retardant compound and 25 vol % to 40 vol % of a cosolvent comprising an organic carbonate solvent.

The battery system of the foregoing paragraph, wherein: the solution further comprises a second salt, the second salt having an anion with a different chemical composition than an anion of the DFOB or BOB salt, wherein cations of the second salt are the same as the cations of the DFOB or BOB salt, a concentration of the second salt is 30 mol % to 70 mol % of the total molar concentration of the salts in the solution, and the anion of the second salt is PF₆⁻, FSI⁻, TFSI⁻, ClO₄⁻, DFOB⁻, BOB⁻, PO₂F₂, or BF₄⁻; or the solution further comprises a second salt and a third salt, each of the second and third salts having anions with a different chemical composition than the anion of the DFOB or BOB salt, and the second salt having an anion with a different chemical composition than the anion of the third salt, wherein cations of the second and third salts are the same as the cations of the DFOB or BOB salt and a combined concentration of the second and third salts is 30 mol % to 70 mol % of the total molar concentration of the salts in the solution, and the anions of the second and third salts are PF₆⁻, FSI⁻, TFSI⁻, ClO₄⁻, DFOB⁻, BOB⁻, PO₂F₂, or BF₄⁻.

The battery system of any of the foregoing paragraphs, wherein the flame retardant compound comprises TEP.

The battery system of any of the foregoing paragraphs, wherein the cosolvent comprises EC.

### V. Examples

### Nonflammable Electrolytes Comprising Five Salts

Four nonflammable electrolytes comprising five different lithium salts were prepared as shown in Table 1:

TABLE 1

| | Molar | | Molar | | Volume |
|---|---|---|---|---|---|
| | Conc. | Salts | Ratio | Solvents | percent |
| EL7 | 1M | LiTFSI/LiFSI/LiDFOB/ | 1/1/2/ | TEP/EC | 68/32 |
| | | LiPF₆/LiPO₂F₂ | 1/1 | | |
| EL7e | 1M | LiTFSI/LiFSI/LiDFOB/ | 1/1/2/ | TEP/EC | 68/32 |
| | | LiPF₆/LiPO₂F₂ + | 1/1 | | |
| | | 1 wt % LiNO₃ | | | |
| EL7n | 1M | LiTFSI/LiFSI/LiDFOB/ | 1/1/4/ | TEP/EC | 68/32 |
| | | LiPF₆/LiPO₂F₂ | 1/1 | | |
| EL15 | 1M | LiTFSI/LiFSI/LiDFOB/ | 1/1/2/ | TEP/EC/ | 60/25/ |
| | | LiPF₆/LiPO₂F₂ | 1/1 | DEC | 15 |

The flammability of EL7 was evaluated and compared to a conventional electrolyte comprising 1 M LiPF₆ in EC/EMC (3:7) with 2 wt % VC. The electrolytes were placed onto a glass dish and directly exposed to fire. The conventional electrolyte ignited within 1 second of contact with a flame. The EL7 electrolyte was contacted with a flame for 6 seconds without igniting. The flash point of EL7 tested with closed cup method is 129° C. while only 25° C. for conventional electrolyte in lithium ion battery, 1 M LiPF₆ in EC/EMC (3:7, vol %) with 2 wt % VC. EL7 has a flashpoint >93° C. and is considered as nonflammable electrolyte according to GHS classification criteria.

The volatility of EL7 was evaluated by placing 2 g of EL7 in a vial and exposing the open vial to air for 24 hours in a fume hood in a dry room with an airflow of 100 m/minute and a dew point of −51 ° C. Over the 24-hour period, EL7 lost only 0.165% of its mass. In contrast, conventional electrolytes typically lose at least 30% of their mass under the same conditions.

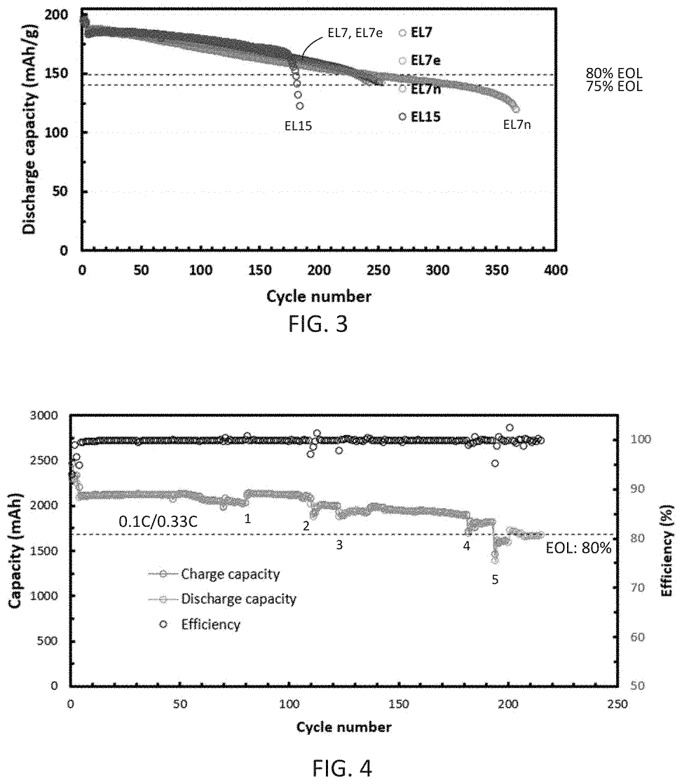

The four nonflammable electrolytes were evaluated in Li/NMC622 coin cells with lean electrolyte (15 μL), and 30-50 μm Li foil as the anode. The cells had a capacity of 3.6-3.9 mAh/cm² and were operated to 100% depth of discharge (DOD). The cells were charged at 0.1 C to 4.4 V and then discharged at 0.33 C to 2.7 V. The number of cycles to reach 80% end of life (EOL) and 75% EOL were determined. The results are shown in FIG. 3 and Table 2. Three of the electrolytes demonstrated >230 stable cycles with >80% capacity retention.

TABLE 2

Cycle Life

| | 80% EOL | 75% EOL |
|---|---|---|
| EL7 | 236 cycles | 253 cycles |
| EL7e | 234 cycles | 243 cycles |
| EL7n | 239 cycles | 313 cycles |
| EL15 | 181 cycles | 182 cycles |

A 350 Wh/kg Li/NMC622 pouch cell (2 Ah) was assembled with the EL7 electrolyte and subjected to 250 cycles (FIG. 4). The pouch cell showed excellent cycling performance with 80% capacity retention after 215 cycles. Apparent discontinuities occurred several times while cycling. The discontinuities numbered 1, 3, 4, and 5 were attributed to cell connection issues. The discontinuity numbered 2 resulted from a bad clamp design. The clamp was replaced and testing continued after a 3-week rest.

In comparison, 7 electrolytes with single salts in pure TEP and 18 electrolytes with two salts in pure TEP were evaluated (FIGS. 5, 6A, 6B). None of them worked well. None of the single-salt electrolytes delivered normal capacity (˜200 mAh/g) in TEP, even at the first formation cycle with 0.03 C. Additionally, 7 electrolytes with single salts in TEP/EC and 21 electrolytes with two salts in TEP/EC were evaluated. EC improved the performance compared to TEP alone. The combination of LiPF₆ and LiDFOB showed similar performance to the EL7e electrolyte after 200 cycles.

FIG. 7 shows cycling performance of 8 electrolytes with single salts in Li/NMC622 coin cells, 2.7-4.4 V, 3.6-3.9 mAh/cm^{2,} with lean electrolyte (15 μL), a 50-μm Li foil anode, and 100% depth of discharge. The capacity retention of the cell with 1 M LiDFOB in TEP/EC (68/32) was 85% after 244 cycles. The capacity retention with 1 M LiBOB in TEP/EC (68/32) was 80% after 183 cycles. The cell with LiDFOB was still running after 240 cycles.

FIGS. 8A-8B show cycling performance of 21 electrolytes with dual salts in Li/NMC622 coin cells, 2.7-4.4 V, 3.6-3.9 mAh/cm^{2,} with lean electrolyte (15 μL), a 50-μm Li foil anode, and 100% depth of discharge. The cells were still running after 200 cycles. Most of the electrolytes comprising LiDFOB or LiBOB demonstrated better performance. The cell with LiPF₆ +LiDFOB (electrolyte 2 of FIG. 8B) exhibited the best performance 87.8% capacity retention after 202 cycles, similar in performance to the EL7e electrolyte. The second best performance was provided by LiFSI+LiDFOB with 86.1% capacity retention after 202 cycles. The cell with LiTFSI+LiDFOB also performed well with 84.8% capacity retention after 202 cycles.

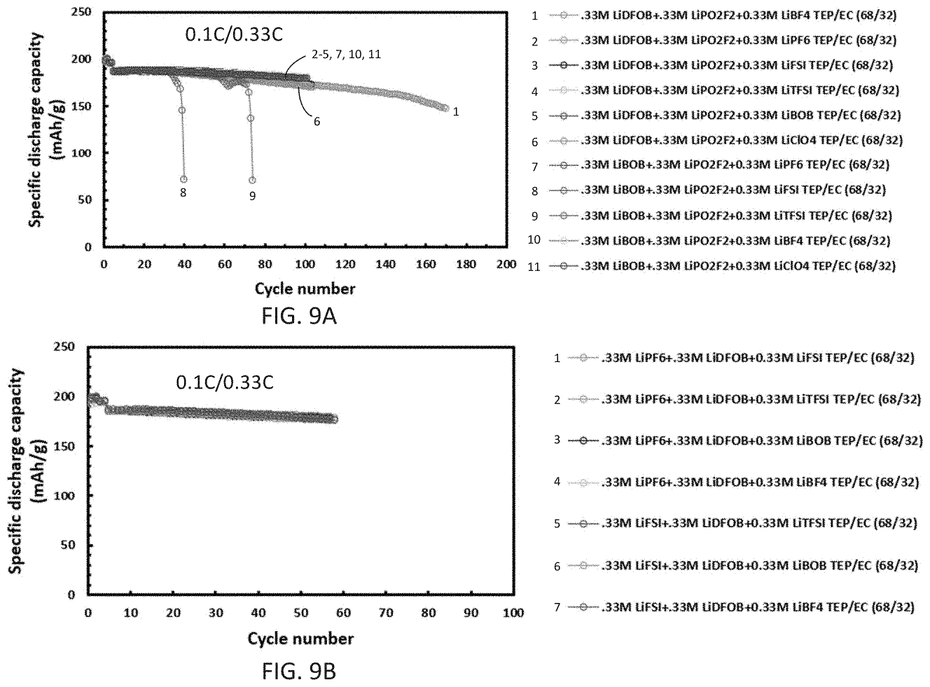

FIGS. 9A-9B show cycling performance of 18 nonflammable electrolytes comprising three salts in TEP/EC (68/32) in Li/NMC622 coin cells, 2.7-4.4 V, 3.6-3.9 mAh/cm^{2,} with lean electrolyte (15 μL), a 50-μm Li foil anode, and 100% depth of discharge. The cells were still running after 100-200 cycles. The most stable performances were achieved with equimolar amounts of LiDFOB/LiPO₂F₂/LiBOB, LiBOB/LiPO₂F₂/LiPF_{6,} and LiBOB/LiPO₂F2/LiC104.

Tables 3-5 show additional salt combinations for evaluation. In each electrolyte, the combined salt concentration is 1 M, and the solvents comprise 68 vol % TEP/32 vol % EC.

TABLE 3
Four Salt Combinations

| Entry | Salts | Molar Ratio |
|---|---|---|
| 1 | LiFSI/LiDFOB/LiPF₆/LiPO₂F₂ | 1/1/1/1 |
| 2 | LiTFSI/LiDFOB/LiPF₆/LiPO₂F₂ | 1/1/1/1 |
| 3 | LiBOB/LiDFOB/LiPF₆/LiPO₂F₂ | 1/1/1/1 |
| 4 | LiFSI/LiDFOB/LiBOB/LiPO₂F₂ | 1/1/1/1 |
| 5 | LiTFSI/LiDFOB/LiBOB/LiPO₂F₂ | 1/1/1/1 |
| 6 | LiFSI/LiBOB/LiPF₆/LiPO₂F₂ | 1/1/1/1 |
| 7 | LiTFSI/LiBOB/LiPF₆/LiPO₂F₂ | 1/1/1/1 |
| 8 | LiFSI/LiTFSI/LiDFOB/LiPF₆ | 1/1/1/1 |
| 9 | LiFSI/LiBOB/LiDFOB/LiF₆ | 1/1/1/1 |
| 10 | LiTFSI/LiBOB/LiDFOB/LiF₆ | 1/1/1/1 |
| 11 | LiPF₆/LiBOB/LiPO₂F₂/LiBF₄ | 1/1/1/1 |
| 12 | LiFSI/LiBOB/LiPO₂F₂/LiBF₄ | 1/1/1/1 |
| 13 | LiTFSI/LiBOB/LiPO₂F₂/LiBF₄ | 1/1/1/1 |
| 14 | LiDFOB/LiBOB/LiPO₂F₂/LiBF₄ | 1/1/1/1 |

TABLE 4
Five Salt Combinations

| Entry | Salts | Molar Ratio |
|---|---|---|
| 1 | LiFSI/LiTFSI/LiDFOB/LiBOB/LiPF₆ | 1/1/1/1/1 |
| 2 | LiFSI/LiTFSI/LiDFOB/LiBOB/LiPF₆ | 1/1/2/1/1 |
| 3 | LiFSI/LiTFSI/LiBOB/LiPO₂F₂/LiPF₆ | 1/1/1/1/1 |
| 4 | LiFSI/LiTFSI/LiBOB/LiPO₂F₂/LiPF₆ | 1/1/2/1/1 |
| 5 | LiTFSI/LiBOB/LiDFOB/LiPO₂F₂/LiPF₆ | 1/1/1/1/1 |
| 6 | LiTFSI/LiBOB/LiDFOB/LiPO₂F₂/LiPF₆ | 1/1/2/1/1 |
| 7 | LiFSI/LiBOB/LiDFOB/LiPO₂F₂/LiPF₆ | 1/1/1/1/1 |
| 8 | LiFSI/LiBOB/LiDFOB/LiPO₂F₂/LiPF₆ | 1/1/2/1/1 |
| 9 | LiFSI/LiTFSI/LiDFOB/LiBOB/LiPO₂F₂ | 1/1/1/1/1 |
| 10 | LiFSI/LiTFSI/LiDFOB/LiBOB/LiPO₂F₂ | 1/1/2/1/1 |
| 11 | LiFSI/LiPF₆/LiDFOB/LiBF₄/LiPO₂F₂ | 1/1/1/1/1 |
| 12 | LiFSI/LiPF₆/LiDFOB/LiBF₄/Li O₂F₂ | 1/1/2/1/1 |

TABLE 5
Six Salt Combinations

| Entry | Salts | Molar Ratio |
|---|---|---|
| 1 | LiFSI/LiTFSI/LiDFOB/LiBOB/LiPF₆/LiBF₄ | 1/1/1/1/1/1 |
| 2 | LiFSI/LiTFSI/LiDFOB/LiBOB/LiPF₆/LiBF₄ | 1/1/2/2/1/1 |
| 3 | LiFSI/LiTFSI/LiDFOB/LiBOB/LiPF₆/LiBF₄ | 1/1/3/1/1/1 |

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A nonflammable electrolyte, comprising:
a solution comprising
(a) at least four different salts, wherein (i) each salt comprises an anion with a different chemical composition than an anion of each of the other salts, (ii) cations of each of the salts are the same, the cations comprising lithium cations, sodium cations, or potassium cations, and (iii) a concentration of each of the salts is 5 mol % of a total molar concentration of the salts in the solution, and
a solvent comprising >50 vol % to 100 vol % of a flame retardant compound and 0 vol % to 50 vol % of a cosolvent; or
(b) a difluoro(oxalato)borate (DFOB) or bis(oxalato)borate (BOB) salt comprising lithium cations, sodium cations, or potassium cations, wherein a concentration of the DFOB or BOB salt is 30 mol % to 100 mol % of a total molar concentration of salts in the solution, and
a solvent comprising 60 vol % to 90 vol % of a flame retardant compound comprising an organic phosphate and 10 vol % to 40 vol % of a cosolvent comprising an organic carbonate solvent.

2. The nonflammable electrolyte of claim 1, wherein:
(i) the total molar concentration of the salts in the solution is 0.5 M to 5 M; or
(ii) the solution comprises at least four different salts and each of the salts is present in an amount of at least 10 mol % of the total molar concentration of the salts; or
(iii) both (i) and (ii).

3. The nonflammable electrolyte of claim 1, wherein the solution comprises 4-10 different salts and each of the salts is present in an amount of from 10 mol % to 70 mol % of the total molar concentration of the salts.

4. The nonflammable electrolyte of claim 1, wherein the solution comprises at least four different salts and each salt comprises an anion selected from bis(fluorosulfonyl)imide (FSI⁻), bis(trifluoromethanesulfonyl)imide (TFSI⁻), bis(pentafluoroethanesulfonyl)imide (BETI⁻), bis(oxalato)borate (BOB⁻), difluoro(oxalato)borate (DFOB⁻), tris(pentafluoroethyl)trifluorophosphate (FAP⁻), PO₂F₂⁻, PF₆⁻, AsF₆⁻, BF₄⁻, CF₃SO₃⁻, ClO₄⁻, I, Br⁻, Cl⁻, SCN⁻, NO₃⁻, NO₂⁻, and SO₄²⁻.

5. The nonflammable electrolyte of claim 4, wherein:
(i) the nonflammable electrolyte comprises DFOB⁻ or BOB⁻ in a molar concentration that is greater than a molar concentration of any other anion in the nonflammable electrolyte and is 70 mol % of a total molar concentration of the anions of the salts in the solution; or
(ii) the nonflammable electrolyte comprises 4-6 different salts comprising anions selected from FSI⁻, TFSI⁻, DFOB⁻, BOB⁻, BF₄⁻, PF₆⁻, and PO₂F₂; or
(iii) both (i) and (ii).

6. The nonflammable electrolyte of claim 1, consisting essentially of:
the salts;
the solvent; and
the cosolvent, if present.

7. The nonflammable electrolyte of claim 1, wherein the concentration of the DFOB or BOB salt is 30 mol % to 70 mol % of the total molar concentration of the salts in the solution, and the solution further comprises:
a second salt, the second salt having an anion with a different chemical composition than an anion of the DFOB or BOB salt, wherein cations of the second salt are the same as the cations of the DFOB or BOB salt and a concentration of the second salt is 30 mol % to 70 mol % of the total molar concentration of the salts in the solution; or
a second salt and a third salt, each of the second and third salts having anions with a different chemical composition than the anion of the DFOB or BOB salt, and the second salt having an anion with a different chemical composition than the anion of the third salt, wherein cations of the second and third salts are the same as the cations of the DFOB or BOB salt and a combined concentration of the second and third salts is 30 mol % to 70 mol % of the total molar concentration of the salts in the solution.

8. The nonflammable electrolyte of claim 7, wherein:
the anion of the second salt is bis(fluorosulfonyl)imide (FSI⁻), bis(trifluoromethanesulfonyl)imide (TFSI⁻), bis(oxalato)borate (BOB⁻), difluoro(oxalato)borate (DFOB⁻), PO₂F₂⁻, PF₆⁻, BF₄⁻, or ClO₄⁻; or
the anions of the second salt and the third salt are FSI⁻, TFSI⁻, BOB⁻, DFOB⁻, PO₂F₂⁻, PF₆⁻, BF₄⁻, or ClO₄⁻.

9. The nonflammable electrolyte of claim 1, wherein the flame retardant compound comprises an organic phosphate, an organic phosphite, an organic phosphonate, an organic phosphoramide, a phosphazene, or any combination thereof.

10. The nonflammable electrolyte of claim 9, wherein the flame retardant compound comprises triethyl phosphate (TEP), trimethyl phosphate (TMP), tributyl phosphate, triphenyl phosphate, tris(2,2,2-trifluoroethyl) phosphate, bis(2,2,2-trifluoroethyl) methyl phosphate, triphenyl phosphite, tris(2,2,2-trifluoroethyl) phosphite; dimethyl methylphosphonate, diethyl ethylphosphonate, diethyl phenylphosphonate, bis(2,2,2-trifluoroethyl) methylphosphonate; hexamethylphosphoramide; hexamethoxyphosphazene, hexafluorophosphazene, or any combination thereof.

11. The nonflammable electrolyte of claim 1, wherein the cosolvent comprises an organic carbonate solvent, an ether solvent, an organic sulfoxide, a sulfone, an organic nitrogen-containing solvent, or any combination thereof.

12. The nonflammable electrolyte of claim 11, wherein the cosolvent comprises ethylene carbonate (EC), dimethyl carbonate (DMC), vinylene carbonate (VC), fluoroethylene carbonate (FEC), difluoroethylene carbonate (DFEC), trifluoroethylene carbonate (TFEC), vinyl ethylene carbonate (VEC), 4-methylene ethylene carbonate (MEC), propylene carbonate (PC), ethyl methyl carbonate (EMC), diethyl carbonate (DEC), methyl 2,2,2-trifluoroethyl carbonate (MFEC), dimethoxyethane (DME), 1,3-dioxolane (DOL), tetrahydrofuran (THF), allyl ether, dimethyl sulfoxide (DMSO), dimethyl sulfone (DMS), ethyl methyl sulfone (EMS), ethyl vinyl sulfone (EVS), tetramethylene sulfone (TMS), trifluoromethyl ethyl sulfone (FMES), trifluoromethyl isopropyl sulfone (FMIS), trifluoropropyl methyl sulfone (FPMS), diethylene glycol dimethyl ether (diglyme), triethylene glycol dimethyl ether (triglyme), tetraethylene glycol dimethyl ether (tetraglyme), methyl butyrate, ethyl propionate, gamma-butyrolactone, acetonitrile (AN), succinonitrile (SN), adiponitrile, triallyl amine, triallyl cyanurate, triallyl isocyanurate, or any combination thereof.

13. The nonflammable electrolyte of claim 1, wherein:
(i) the flame retardant compound comprises TEP; or
(ii) the cosolvent comprises EC; or
(iii) both (i) and (ii).

14. The nonflammable electrolyte of claim 1, comprising:
(i) LiFSI, LiTFSI, LiDFOB, LiPF₆, LiPO₂F₂, TEP, and EC; or
(ii) LiDFOB or LiBOB, wherein the concentration of the LiDFOB or LiBOB is 40 mol % to 100 mol % of the total molar concentration of salts in the solution, TEP, and EC.

15. The nonflammable electrolyte of claim 7, comprising:
TEP, EC, LiDFOB or LiBOB, and the second salt, wherein the second salt comprises LiPF₆, LiFSI, LiTFSI, LiClO₄, LiDFOB, LiBOB, LiPO₂F₂, or LiBF₄; or
TEP, EC, LiDFOB or LiBOB, the second salt, and the third salt, wherein each of the second and third salts comprises LiPF₆, LiFSI, LiTFSI, LiClO₄, LiDFOB, LiBOB, LiPO₂F₂, or LiBF₄.

16. A battery system, comprising:
the nonflammable electrolyte according to claim 1;
a cathode; and
an anode current collector in the absence of an anode, or an anode comprising lithium metal, sodium metal, potassium metal, an intercalation material, or a conversion compound.

17. The battery system of claim 16, wherein:
the anode comprises lithium metal; and
the cathode comprises Li_{1+w}NiₓMn_{y}Co_{z}O₂(x+y+z+w=1, 0≤w≤0.25), LiNiₓMn_{y}Co_{z}O₂ (x+y+z=1), LiNi_{0.8}Co_{0.15}Al_{0.05}O₂ LiCoO₂, LiNi_{0.5}Mn_{1.5}O₄ spinel, LiMn₂O₄, LiFePO₄, Li₄₋ₓMₓTi₅O₁₂ (M=Mg, Al, Ba, Sr, or Ta; 0≤x≤1), MnO₂, V₂O₅, V₆O₁₃, LiVₑO₈, LiM^{C1}ₓM^{C2}₁₋ₓPO₄ (M^{C1} or M^{C2}=Fe, Mn, Ni, Co, Cr, or Ti; 0≤x≤1), Li₃V₂₋ₓM¹ₓ(PO₄)₃ (M¹=Cr, Co, Fe, Mg, Y, Ti, Nb, or Ce; 0≤x≤1), LiVPO₄F, LiM^{C1}ₓM^{C2}₁₋ₓO₂ ((M^{C1} and M^{C2} independently are Fe, Mn, Ni, Co, Cr, Ti, Mg, or Al; 0≤x≤1), LiM^{C1}ₓM^{C2}_{y}M^{C3}_{1-x-y}O₂ ((M^{C1}, M^{C2}, and M^{C3} independently are Fe, Mn, Ni, Co, Cr, Ti, Mg, or Al; 0≤x≤1; 0≤y≤1), LiMn_{2-y}X_{y}O₄ (X=Cr, Al, or Fe, 0≤y≤1), LiNi_{-.5-y}X_{y}Mn_{1.5}O₄ (X=Fe, Cr, Zn, Al, Mg, Ga, V, or Cu; 0≤y<0.5), xLi₂MnO₃·(1-x)LiM^{C1}_{y}M^{C2}_{z}M^{C3}_{1-y-z}O₂ (M^{C1}, M^{C2}, and M^{C3} independently are Mn, Ni, Co, Cr, Fe, or mixture thereof; x=0.3−0.5; y≤0.5; z≤0.5), Li₂M²SiO₄ (M²=Mn, Fe, or Co), Li₂M²SO₄ (M²=Mn, Fe, or Co), LiM²SO₄F (M²=Fe, Mn, or Co), Li₂₋ₓ(Fe_{1-y}Mn_{y})P₂O₇ (0≤y≤1), Cr₃O₈, Cr₂O₅, a carbon/sulfur composite, or an air electrode.

18. The battery system of claim 16, wherein the battery system is a pouch cell comprising:
the anode current collector in the absence of the anode, or the anode, wherein the anode comprises lithium metal, sodium metal, or potassium metal;
the cathode;
a separator;
the nonflammable electrolyte; and
a packaging material defining a pouch enclosing the anode, the cathode, the separator, and the nonflammable electrolyte.

19. The battery system of claim 16, wherein:
the nonflammable electrolyte comprises 4-6 different salts;
the anions are selected from FSI⁻, TFSI⁻, DFOB⁻, BOB⁻, PF₆⁻, and PO₂F₂⁻; and
the solvent comprises 60-75 vol % of the flame retardant compound and 25 vol % to 40 vol % of a cosolvent comprising an organic carbonate solvent.

20. The battery system of claim 16, wherein:
the solution comprises a difluoro(oxalato)borate (DFOB) or bis(oxalato)borate (BOB) salt, wherein a concentration of the DFOB or BOB salt is 40 mol % to 100 mol % of a total molar concentration of salts in the solution; and
the solvent comprises 60-75 vol % of the flame retardant compound and 25 vol % to 40 vol % of a cosolvent comprising an organic carbonate solvent.
